(19) United States
(12) Patent Application Publication
(10) Pub. No.: US 2026/0257354 A1
(43) Pub. Date: Sep. 3, 2026

(54) CONTROL METHOD AND APPARATUS FOR ROBOT SYSTEM, SYSTEM, AND STORAGE MEDIUM

(71) Applicant: Tencent Technology (Shenzhen) Company Limited, Shenzhen (CN)

(72) Inventors: Xinghua YU, Shenzhen (CN); Cheng ZHOU, Shenzhen (CN)

(73) Assignee: Tencent Technology (Shenzhen) Company Limited, Shenzhen, GD (CN)

(21) Appl. No.: 19/657,481

(22) Filed: Apr. 24, 2026

Related U.S. Application Data
(63) Continuation of application No. PCT/CN2025/077567, filed on Feb. 17, 2025.

(30) Foreign Application Priority Data
Feb. 22, 2024 (CN) 202410200537.6

(51) Int. Cl. B25J 9/16

(52) U.S. Cl. CPC B25J 9/1633; B25J 9/1605; B25J 9/1653

(57) ABSTRACT

A control method and apparatus for a robot system, a robot system, and a storage medium are provided. The robot system includes at least one robot joint module, and each robot joint module includes a motor and a joint. The control method includes: determining a sensor configuration state of the robot joint module; determining, based on parameter measurement values collected in the sensor configuration state and a parameter determination policy corresponding to the sensor configuration state, a motor parameter and a joint parameter that are configured for closed-loop control of the robot joint module; and determining a motor control torque of the motor based on the motor parameter, the joint parameter, and a control policy, and controlling the motor to implement closed-loop control of the robot joint module.

### RELATED APPLICATION

This application is a continuation of International Patent Application No. PCT/CN2025/077567, filed Feb. 17, 2025, which claims priority to Chinese Patent Application 202410200537.6, entitled “CONTROL METHOD AND APPARATUS FOR ROBOT SYSTEM, SYSTEM, AND STORAGE MEDIUM” and filed on Feb. 22, 2024. The contents of International Patent Application No. PCT/CN2025/077567 and Chinese Patent Application 202410200537.6 are herein incorporated by reference in their entirety.

### FIELD OF THE TECHNOLOGY

Embodiments of this application relate to the technical field of robot control, and in particular, to a control method and apparatus for a robot system, a system, and a storage medium.

### BACKGROUND OF THE DISCLOSURE

Some complex robot systems typically incorporate numerous transmission and proprioceptive solutions. A transmission system of a robot may exhibit flexibility, but proprioception of the robot might vary due to configuration of joint sensors and motor sensors within the robot system.

In the related art, to ensure control precision, parameter identification and control are usually performed only for a particular robot system. However, parameter models have poor generalization ability and are generally only configured for development of a single robot system. As a result, a corresponding robot control policy can only be formulated based on a sensor configuration scheme corresponding to the single robot system, leading to high control costs.

### SUMMARY

Embodiments of this application provide a control method and apparatus for a robot system, a system, and a storage medium. Technical solutions are provided as follows:

According to an aspect, embodiments of this application provide a control method for a robot system. The method is performed by a robot system, the robot system includes at least one robot joint module, each of the at least one robot joint module includes a motor and a joint, and the motor is configured to drive the joint to implement joint motion.

The method includes:
determining a sensor configuration state of the robot joint module, the sensor configuration state including a motor sensor configuration state of the motor in the robot joint module and a joint sensor configuration state of the joint in the robot joint module;
determining, based on parameter measurement values collected in the sensor configuration state and a parameter determination policy corresponding to the sensor configuration state, a motor parameter and a joint parameter that are configured for closed-loop control of the robot joint module; and
determining a motor control torque of the motor based on the motor parameter, the joint parameter, and a control policy, and controlling the motor to implement closed-loop control of the robot joint module.

According to another aspect, embodiments of this application provide a control apparatus for a robot system. The robot system includes at least one robot joint module, each of the at least one robot joint module includes a motor and a joint, and the motor is configured to drive the joint to implement joint motion.

The apparatus includes:
a state determination module, configured to determine a sensor configuration state of the robot joint module, the sensor configuration state including a motor sensor configuration state of the motor in the robot joint module and a joint sensor configuration state of the joint in the robot joint module;
a parameter determination module, configured to determine, based on parameter measurement values collected in the sensor configuration state and a parameter determination policy corresponding to the sensor configuration state, a motor parameter and a joint parameter that are configured for closed-loop control of the robot joint module; and
a control module, configured to determine a motor control torque of the motor based on the motor parameter, the joint parameter, and a control policy, and control the motor to implement closed-loop control of the robot joint module.

According to another aspect, embodiments of this application provide a robot system. The robot system includes a processor and a memory. The memory has at least one computer instruction stored therein. The at least one computer instruction is executed by the processor to implement the control method for a robot system according to the foregoing aspect.

According to another aspect, embodiments of this application provide a computer-readable storage medium. The computer-readable storage medium stores at least one computer instruction, and the at least one computer program is loaded and executed by a processor to implement the control method for a robot system according to the foregoing aspect.

According to another aspect, embodiments of this application provide a computer program product. The computer program product includes computer instructions, and the computer instructions are stored in a computer-readable storage medium. A processor of a robot system reads the computer instructions from the computer-readable storage medium and executes the computer instructions, to cause the robot system to perform the control method for a robot system according to the foregoing aspect.

In the embodiments of this application, to perform closed-loop control on the robot joint module having different sensor configuration states in a unified control framework, the sensor configuration state of the robot joint module first needs to be determined, then, the motor parameter and the joint parameter that are required for closed-loop control of the robot joint module are determined based on the parameter measurement values collected in the sensor configuration state and the parameter determination policy corresponding to the current sensor configuration state, and finally, the motor control torque corresponding to the control policy is obtained based on the motor parameter, the joint parameter, and the control policy, and the motor is controlled based on the motor control torque, to implement closed-loop control of the robot joint module. According to the solutions provided in the embodiments of this application, corresponding parameter determination policies are set for different sensor configuration states, to obtain a full set of motor parameters and a full set of joint parameters that are required for closed-loop control, and then closed-loop control is performed on the robot joint module in different sensor configuration states by using the unified control framework, without the need for adopting a particular control policy for the robot joint module in different sensor configuration states.

This enhances control precision of the robot joint module and reduces control costs of the robot system.

### BRIEF DESCRIPTION OF THE DRAWINGS

FIG. 1 is a schematic diagram of an implementation environment according to an exemplary embodiment of this application.

FIG. 2 is a flowchart of a control method for a robot system according to an exemplary embodiment of this application.

FIG. 3 is a flowchart of a control method for a robot system according to another exemplary embodiment of this application.

FIG. 4 is a schematic diagram of motor side and joint side parameter division in a robot joint module according to an exemplary embodiment of this application.

FIG. 5 is a schematic diagram of a full-state feedback controller where a motor is controlled based on a first motor control torque according to an exemplary embodiment of this application.

FIG. 6 is a schematic diagram of a full-state feedback controller where a motor is controlled based on a second motor control torque according to an exemplary embodiment of this application.

FIG. 7 is a flowchart of performing parameter calibration on a robot joint module according to an exemplary embodiment of this application.

FIG. 8 is a flowchart of performing parameter calibration on a robot joint module according to another exemplary embodiment of this application.

FIG. 9 is a diagram of an implementation framework of a control algorithm for a robot system according to an exemplary embodiment of this application.

FIG. 10 is a structural block diagram of a control apparatus for a robot system according to an exemplary embodiment of this application.

FIG. 11 is a schematic structural diagram of a robot system according to an exemplary embodiment of this application.

### DESCRIPTION OF EMBODIMENTS

To make the objectives, technical solutions, and advantages of this application clearer, the following further describes implementations of this application in detail with reference to the accompanying drawings.

To apply a robot system to a variety of fields to perform different tasks, transmission and proprioceptive solutions incorporated in the robot system have gradually diversified, resulting in increased difficulty in controlling the robot system. In the related art, to ensure control precision, a corresponding control policy is usually formulated only for a particular robot joint module. That is, different robot joint modules need to be controlled based on different control policies due to different transmission and perception solutions, resulting in increased control costs of the robot system. For example, for a single robot, a harmonic drive solution and a single sensor configuration manner are typically adopted. However, for a humanoid robot, lower limbs of the humanoid robot need to bear the entire weight of upper limbs, that is, different transmission solutions and sensor configuration manners need to be adopted for the upper and lower limbs.

However, in embodiments of this application, a corresponding parameter determination policy is set for a sensor configuration state of a robot joint module. In this way, a full set of motor parameters and a full set of joint parameters that are configured for closed-loop control of the robot joint module may be determined based on parameter measurement values collected in the sensor configuration state, a motor control torque of a motor is determined based on a control policy and a unified closed-loop control framework, and the motor is controlled, to implement closed-loop control of the robot joint module. This ensures control precision of the robot joint module and reduces control costs of the robot joint module.

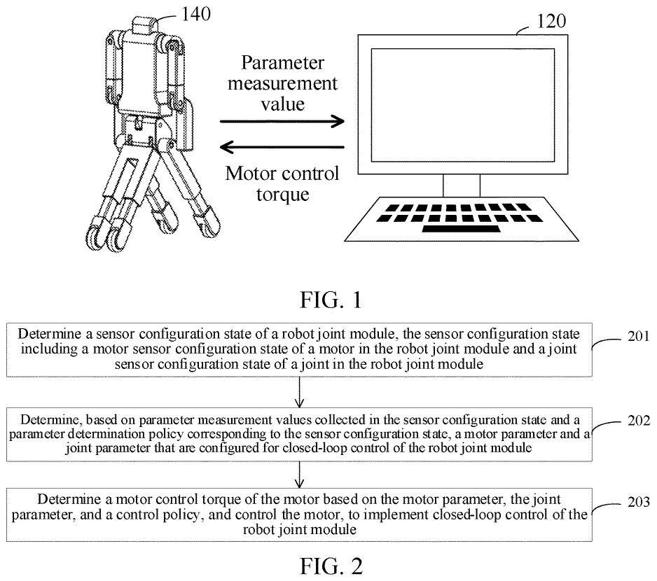

FIG. 1 is a schematic diagram of an implementation environment according to an embodiment of this application. The implementation environment includes a computer device 120 and a robot system 140.

The computer device 120 refers to a device equipped with an application program that has a function of controlling a robot system. The function of controlling a robot system may be a function of a native application in the computer device 120 or a function of a third-party application. The computer device 120 may be a smartphone, a tablet computer, a notebook computer, a desktop computer, a smart television, a wearable device, an in-vehicle terminal, or the like. In FIG. 1, a description is made by using an example in which the computer device 120 is a desktop computer, but does not construct a limitation on the computer device.

The robot system 140 includes at least one robot joint module. Each robot joint module includes a motor and a joint. The motor is configured to drive the joint to implement joint motion. The robot system 140 may be a single robot system such as a robotic arm, or may be a complex robot system, such as a humanoid robot or a wheeled robot. This is not limited in embodiments of this application. In an embodiment, the robot system 140 may be controlled by an internal controller, or may be controlled by a connected computer device. This is not limited in embodiments of this application.

In a possible implementation, as shown in FIG. 1, the robot system 140 is controlled by the computer device 120 connected to the robot system. The computer device 120 determines sensor configuration states of robot joint modules in the robot system 140 based on received data that is collected by sensors; determines, based on a parameter determination policy corresponding to a current sensor configuration state and parameter measurement values, a motor parameter and a joint parameter that are configured for closed-loop control of the robot joint modules; and further determines motor control torques corresponding to the robot joint modules based on the motor parameter, the joint parameter, and the control policy, and returns the motor control torques to the robot system 140. The robot system 140 controls running of the robot joint modules.

In another possible implementation, the robot system 140 is controlled by an internal controller. The robot system 140 determines sensor configuration states of robot joint modules based on data collected by sensors corresponding to the robot joint modules; determines, based on a parameter determination policy corresponding to a current sensor configuration state and parameter measurement values, a motor parameter and a joint parameter that are configured for closed-loop control of the robot joint modules; and further determines, based on the motor parameter, the joint parameter, and a control policy, motor control torques corresponding to the robot joint modules, and performs closed-loop control on the robot joint modules based on the corresponding motor control torques.

For ease of description, the following embodiments are described by using an example in which a control method for a robot system is performed by a robot system.

FIG. 2 is a flowchart of a control method for a robot system according to an exemplary embodiment of this application. This embodiment is described by using an example in which the method is applied to a robot system. The method includes the following operations:

Operation 201: Determine a sensor configuration state of a robot joint module, the sensor configuration state including a motor sensor configuration state of a motor in the robot joint module and a joint sensor configuration state of a joint in the robot joint module.

In an embodiment, the robot system may be classified into a single robot system (such as a robotic arm) and a complex robot system (such as a humanoid robot). The single robot system includes a single robot joint module, and the complex robot system includes a plurality of robot joint modules.

In an embodiment, a robot joint module is typically a flexible joint. That is, the robot joint module undergoes flexible deformation upon collision, to mitigate the impact force on the robot joint module and achieve a cushioning effect. The robot joint module includes a motor and a joint. The motor and the joint are connected via a spring and a damper. Joint motion may be implemented by controlling the motor to drive the joint, and a corresponding robot task is performed based on the joint motion.

In an embodiment, the robot joint module may use different transmission solutions to enable the motor to drive the joint, such as gear transmission, tendon transmission, a harmonic reducer, and a ball screw. In addition, although both the motor and the joint theoretically possess proprioceptive capabilities, that is, both the motor and the joint can measure and collect a motor parameter and a joint parameter by directly configuring sensors, in actual design, a quantity of sensor configurations is usually reduced, to meet requirements of structural layout and design costs of the robot joint module. For example, a motor sensor instead of a joint sensor is configured in the robot joint module, or some motor sensors, some joint sensors, or the like are configured.

In a possible implementation, to control the robot system, that is, control the robot joint modules in the robot system, the robot system first needs to determine the sensor configuration state of the robot joint module. The sensor configuration state includes the motor sensor configuration state of the motor and the joint sensor configuration state of the joint.

The motor sensor configuration state refers to a state of a motor sensor configured on the motor, and the motor sensor includes a motor torque sensor and a motor position sensor. In the embodiments of this application, two types of motor sensor configuration states are provided. In a first type, both the motor torque sensor and the motor position sensor are configured. In a second type, only the motor torque sensor is configured and the motor position sensor is not configured.

The joint sensor configuration state refers to a state of a joint sensor configured on the joint, and the joint sensor includes a joint torque sensor and a joint position sensor. In the embodiments of this application, four types of joint sensor configuration states are provided. In a first type, both the joint torque sensor and the joint position sensor are configured. In a second type, only the joint torque sensor is configured and the joint position sensor is not configured. In a third type, only the joint position sensor is configured and the joint torque sensor is not configured. In a fourth type, neither the joint torque sensor nor the joint position sensor is configured.

Operation 202: Determine, based on parameter measurement values collected in the sensor configuration state and a parameter determination policy corresponding to the sensor configuration state, a motor parameter and a joint parameter that are configured for closed-loop control of the robot joint module.

In the related art, the robot joint module is controlled directly based on the parameter measurement values collected by the robot joint module in the current sensor configuration state. Consequently, because the collected parameter measurement values are not a full set of parameter measurement values, the problem of closed-loop control at the motor level but open-loop control at the joint level may occur, resulting in low control precision. In the embodiments of this application, to implement overall closed-loop control of the robot joint module, after the parameter measurement values collected in the sensor configuration state are obtained, a full set of motor parameters and a full set of joint parameters that are configured for closed-loop control of the robot joint module are further determined based on the corresponding parameter determination policy.

In an embodiment, the full set of motor parameters refer to motor parameters including a motor angle and a motor torque. The motor angle refers to a position of a motor rotor relative to a motor stator during running of the motor, and is typically expressed in radians or degrees. The motor angle may be directly measured by the motor position sensor configured on the motor. The motor torque refers to a rotation torque generated during running of the motor, and is typically expressed in Newton-meters. The motor torque may be directly measured by the motor torque sensor configured on the motor.

In an embodiment, the full set of joint parameters refer to joint parameters including a joint angle and a joint torque. The joint angle refers to a rotation angle of the joint relative to a reference coordinate system, and is typically expressed in radians or degrees. The joint angle may be directly measured by the joint position sensor configured on the joint. The joint torque refers to a torque acting on the joint, and is typically expressed in Newton-meters. The joint torque may be directly measured by the joint torque sensor configured on the joint.

In a possible implementation, where the sensors are fully configured for both the motor and the joint, the robot system may directly determine the collected parameter measurement values as the motor parameter and the joint parameter that are configured for closed-loop control.

In another possible implementation, where the sensors are not fully configured for the motor or the joint, the robot system needs to determine, based on the parameter determination policy corresponding to the current sensor configuration state and the collected parameter measurement values, a motor parameter or a joint parameter that is not collected, to obtain the full set of motor parameters and the full set of joint parameters.

The parameter determination policy refers to a policy of determining remaining uncollected parameters based on collected parameter measurement values. For example, where the motor position sensor is not configured, the parameter determination policy refers to a policy of determining a motor angle simulation value based on at least one of a motor torque measurement value, a joint angle measurement value, and a joint torque measurement value that have been collected. For another example, where the joint position sensor is not configured, the parameter determination policy refers to a policy of determining a joint angle simulation value based on at least one of a motor torque measurement value, a motor angle measurement value, and a joint torque measurement value that have been collected.

Operation 203: Determine a motor control torque of the motor based on the motor parameter, the joint parameter, and a control policy; and control the motor, to implement closed-loop control of the robot joint module.

In some embodiments, to enhance control precision of the robot joint module, in addition to the motor and the joint, the robot joint module further includes a controller. The controller outputs the motor control torque to the motor, to cause the motor to run based on the motor control torque. The motor control torque refers to a control quantity configured for controlling running of the motor during closed-loop control of the robot joint module, and may be understood as a desired motor torque.

In an embodiment, the control policy refers to a method or an algorithm configured for controlling a robot joint module to complete a particular task. In an embodiment, different controllers have different control policies, such as inverse kinematics-based control policy and a Cartesian desired force-based control policy.

In an embodiment, the control policy may further be classified into an open-loop control policy and a closed-loop control policy. In the open-loop control policy, the motor control torque only needs to be determined based on some motor parameters or joint parameters. Therefore, control precision is low. In the closed-loop control policy, the motor control torque needs to be determined based on the full set of motor parameters and the full set of joint parameters. Therefore, control precision is high.

Because in the embodiments of this application, corresponding parameter determination policies are set for different sensor configuration states, in the embodiments of this application, based on different sensor configuration states corresponding to different robot joint modules, the full set of motor parameters and the full set of joint parameters can be determined based on parameter determination policies and collected parameter measurement values, to implement closed-loop control of the robot joint module.

In some embodiments, after obtaining the full set of motor parameters and the full set of joint parameters, the robot system may apply the motor parameter and the joint parameter to a corresponding control policy, to determine a motor control torque based on the control policy, and control the motor based on the motor control torque, to implement closed-loop control of the robot joint module.

In conclusion, in the embodiments of this application, to perform closed-loop control on the robot joint module having different sensor configuration states in a unified control framework, the sensor configuration state of the robot joint module first needs to be determined. Then, the motor parameter and the joint parameter that are required for closed-loop control of the robot joint module are determined based on the parameter measurement values collected in the sensor configuration state and the parameter determination policy corresponding to the current sensor configuration state. Finally, the motor control torque corresponding to the control policy is obtained based on the motor parameter, the joint parameter, and the control policy, and the motor is controlled based on the motor control torque, to implement closed-loop control of the robot joint module. According to the solutions provided in the embodiments of this application, corresponding parameter determination policies are set for different sensor configuration states, to obtain a full set of motor parameters and a full set of joint parameters that are required for closed-loop control. Then, closed-loop control is performed on the robot joint module in different sensor configuration states by using the unified control framework, without the need for adopting a particular control policy for the robot joint module in different sensor configuration states. This enhances control precision of the robot joint module and reduces control costs of the robot system.

In some embodiments, to improve accuracy of determining the motor parameter and the joint parameter, the robot system may use different parameter determination policies for different sensor configuration states. A process of determining parameters in different sensor configuration states is described below through a specific embodiment.

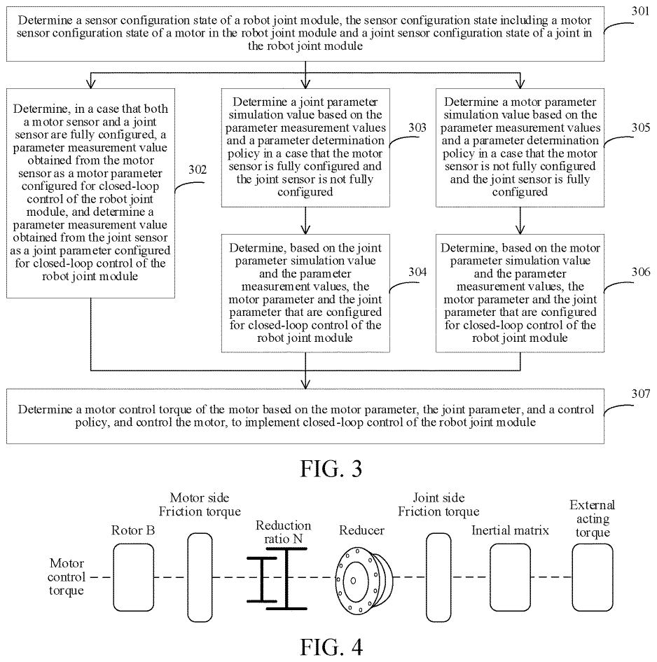

FIG. 3 is a flowchart of a control method for a robot system according to another exemplary embodiment of this application.

Operation 301: Determine a sensor configuration state of a robot joint module, the sensor configuration state including a motor sensor configuration state of a motor in the robot joint module and a joint sensor configuration state of a joint in the robot joint module.

For a specific implementation of operation 301, refer to operation 201. Details are not described herein again in this embodiment.

Operation 302: Determine, where both a motor sensor and a joint sensor are fully configured, a parameter measurement value obtained from the motor sensor as a motor parameter configured for closed-loop control of the robot joint module, and determine a parameter measurement value obtained from the joint sensor as a joint parameter configured for closed-loop control of the robot joint module.

In some embodiments, when both the motor sensor and the joint sensor are fully configured, the robot system may directly determine a full set of motor parameters and a full set of joint parameters based on motor parameter measurement values obtained from the motor sensor and joint parameter measurement values obtained from the joint sensor.

In a possible implementation, the motor parameter may include a motor angle and a motor torque. When the motor sensor is fully configured, the motor sensor includes a motor position sensor (configured to measure a motor angle) and a motor torque sensor (configured to measure a motor torque).

In an embodiment, the motor angle may be denoted as θ, and the motor torque may be denoted as τₘ.

In a possible implementation, the joint parameter may include a joint angle and a joint torque. When the joint sensor is fully configured, the joint sensor includes a joint position sensor (configured to measure a joint angle) and a joint torque sensor (configured to measure a joint torque).

In an embodiment, the joint torque may be denoted as τ, and the joint angle may be denoted as q.

In some embodiments, considering that during practical running of the robot joint module, sensors may not be fully configured, to implement closed-loop control of the robot joint module, parameter simulation value calculation needs to be performed, based on the parameter determination policy, on a motor parameter or a joint parameter that are not collected.

In some embodiments when the motor sensor or the joint sensor is not fully configured, the motor sensor is fully configured but the joint sensor is not fully configured, the motor sensor is fully configured but the joint sensor is partially configured, or the joint sensor is fully configured but the motor sensor is partially configured.

As used herein, the motor sensor being partially configured means that only the motor torque sensor is configured. Also, as used herein, the joint sensor being partially configured means that only the joint torque sensor is configured, or only the joint position sensor is configured.

In some embodiments, when the motor sensor or the joint sensor is not fully configured, the robot system cannot directly obtain the full set of motor parameters and the full set of joint parameters based on the parameter measurement values. Therefore, to implement closed-loop control of the robot joint module, the robot system needs to determine, based on the existing parameter measurement values in an indirect simulation manner, a parameter simulation value corresponding to a sensor that is not configured.

In a possible implementation, because different parameter measurement values are collected in different sensor configuration states, different parameter simulation values need to be determined. Therefore, to improve determination efficiency of the parameters, in the embodiments of this application, corresponding parameter determination policies are set for different sensor configuration states. In this way, the robot system may calculate corresponding motor parameter simulation values or joint parameter simulation values based on the parameter measurement values in the current sensor configuration state and the parameter determination policy.

Exemplarily, as shown in FIG. 4, in a process of determining a parameter simulation value, parameters of the robot joint module that may be involved may be classified into motor-side parameters and joint-side parameters, with a reducer as a center. The motor-side parameter may include a rotor moment of inertia B, a motor-side friction torque, a reduction ratio, and the like. The joint-side parameter may include a joint-side friction torque, an inertial matrix, an external acting torque, and the like.

Exemplarily, Table 1 shows several possible sensor configuration states involved in the embodiments of this application. However, the embodiment of this application may further be applied to other possible sensor configuration states. A sensor configuration type is not specifically limited in the embodiment of this application.

TABLE 1

| | Motor torque | Motor position | Joint torque | Joint position |
|---|---|---|---|---|
| | sensor | sensor | sensor | sensor |
| Type 1 | Has | Has | Has | Has |
| Type 2 | Has | Has | Has | None |
| Type 3 | Has | Has | None | Has |
| Type 4 | Has | Has | None | None |
| Type 5 | Has | None | Has | Has |

The following describes a case that the joint sensor is not fully configured and a case that the motor sensor is not fully configured, respectively.

Implementations when the Joint Sensor is not Fully Configured

Operation 303: Determine a joint parameter simulation value based on the parameter measurement values and a parameter determination policy where the motor sensor is fully configured and the joint sensor is not fully configured.

In some embodiments, the joint sensor not being fully configured may include: neither a joint torque sensor nor a joint position sensor is configured, only the joint torque sensor is configured and the joint position sensor is not configured, or only the joint position sensor is configured and the joint torque sensor is not configured.

In a case that neither the joint torque sensor nor the joint position sensor is configured, the robot system needs to determine a joint angle simulation value and a joint torque simulation value based on collected motor parameter measurement values and the parameter determination policy.

In a case that only the joint torque sensor is configured and the joint position sensor is not configured, the robot system needs to determine a joint angle simulation value based on collected motor parameter measurement values, a joint torque measurement value, and the parameter determination policy.

In a case that only the joint position sensor is configured and the joint torque sensor is not configured, the robot system needs to determine the joint torque simulation value based on collected motor parameter measurement values, a joint angle measurement value, and the parameter determination policy.

The following describes a process of determining a parameter simulation value in different joint sensor configuration states.
1) In a case that the motor sensor is fully configured and the joint sensor is not configured, the joint angle simulation value and the joint torque simulation value are obtained in an indirect simulation manner based on a motor torque measurement value and a motor angle measurement value.

In some embodiments, to simplify a configuration structure and reduce costs, the robot joint module is configured with a motor torque sensor and a motor position sensor only at a motor end, and is not configured with a joint torque sensor and a joint position sensor at a joint end. Therefore, after obtaining the motor torque measurement value based on the motor torque sensor and the motor angle measurement value based on the motor position sensor, the robot system needs to determine the joint angle simulation value and the joint torque simulation value in an indirect simulation manner.

In a possible implementation, the robot system first obtains a motor angular velocity through first-order differential calculation based on the motor angle measurement value, and obtains a motor angular acceleration through second-order differential calculation. Further, to obtain the parameter simulation values on the joint side, the robot system needs to determine a reducer input torque between the motor and the joint based on a first dynamic feature of the motor, the motor angular acceleration, and the motor torque measurement value.

In an embodiment, the motor angle measurement value may be denoted as θ(t), the motor angular velocity may be denoted as \dot{θ}(t), and the motor angular acceleration may be denoted as \ddot{θ}(t). By using a first dynamic equation τₘ(t)=B\ddot{θ}(t)+τ_{f}(t)+τ_{w}(t) for the motor, the robot system may obtain the reducer input torque τ_{w} through inverse solution, where t denotes a current moment, τₘ denotes the motor torque measurement value, B denotes the rotor moment of inertia, and τ_{f} denotes a motor friction torque.

Further, considering that the joint has a delay effect relative to running of the motor, to simulate a joint angular velocity at a current moment, the robot system may first replace the joint angle at the current moment with a joint angle at a previous moment, and then the robot system may solve a joint angular velocity simulation value at the current moment based on a second dynamic feature of the joint, the reducer input torque, a stiffness characteristic between a motor angle at the current moment and a joint angle at the previous moment, and a damping characteristic between a motor angular velocity at the current moment and the joint angular velocity.

In an embodiment, the joint angle at the previous moment may be denoted as q(t−1). The robot system may determine the joint angular velocity q(t) at the current moment based on the second dynamic feature τ_{w}(t)=K(θ(t)−q(t−1))+D(\dot{θ}(t)−\dot{q}(t)) of the joint, where τ_{w}(t) denotes the reducer input torque at the current moment, K denotes a joint stiffness coefficient, and D denotes a joint damping coefficient.

After obtaining the joint angular velocity simulation value at the current moment, the robot system may determine a joint angular acceleration estimation value by performing differential processing on the joint angular velocity simulation value, and may further determine an external acting torque estimation value at the current moment based on a third dynamic feature of the joint, the joint angular velocity simulation value, the joint angular acceleration estimation value, and the joint angle at the previous moment.

In an embodiment, the joint angular acceleration may be denoted as q(t). The robot system may solve the external acting torque estimation value \hat{τ}ₑₓₜ(t) at the current moment based on the third dynamic feature τ_{w}(t)=M(q(t−1))\hat{\ddot{q}}(t)+C(q(t−1),\dot{q}(t)\dot{q}(t)+g(q(t−1)+τ_{q}(t)−\hat{τ}ₑₓₜ(t) of the joint, where \hat{\ddot{q}}(t) denotes the joint angular acceleration estimation value at the current moment, M(q) denotes an inertial matrix between the motor and the joint, C(q, \dot{q}) denotes a centrifugal and Coriolis matrix, g(q) denotes a gravity matrix, τ_{q} denotes a joint friction torque, and \hat{τ}ₑₓₜ denotes an external acting torque.

In an embodiment, the third dynamic feature of the joint may be transformed into \ddot{q}(t)=M⁻¹(q(t−1))[τ_{w}(t)−(C(q(t−1),\dot{q}(t)\dot{q}(t)+g(q(t−1)+τ_{q}(t)−\hat{τ}ₑₓₜ(t))]. Further, the robot system may substitute the external acting torque estimation value back into the third dynamic feature of the joint, to determine the joint angular acceleration simulation value at the current moment, and then obtain the joint angle simulation value through numerical integration based on the joint angle at the previous moment, the joint angular velocity simulation value, and the joint angular acceleration simulation value.

After obtaining the joint angle simulation value is obtained, the robot system may determine the joint torque simulation value based on the stiffness characteristic between the motor angle and the joint angle. In a possible implementation, the robot system may first determine an angle difference between the motor angle and the joint angle based on a fourth dynamic feature of the joint, the motor angle measurement value, and the joint angle simulation value, and then perform stiffness calculation on the angle difference based on the joint stiffness coefficient, to obtain the joint torque simulation value.

In an embodiment, the fourth dynamic feature of the joint may be expressed as τ(t)=K(θ(t)−q(t)), where τ(t) denotes a joint torque at the current moment, K denotes the joint stiffness coefficient, θ(t) denotes a motor angle at the current moment, and q(t) denotes a joint angle at the current moment.

In a configuration when the joint sensor is not configured, the joint angle simulation value is first obtained through simulation calculation based on the dynamic features of the motor and the joint, the motor torque measurement value, and the motor angle measurement value, and then the joint torque simulation value is obtained through simulation calculation based on the motor angle measurement value and the joint angle simulation value, to obtain the full set of joint parameters. This ensures closed-loop control of the robot joint module and enhances control precision.
2) In a case that the motor sensor is fully configured and the joint torque sensor is configured, the joint angle simulation value is obtained in an indirect simulation manner based on the motor torque measurement value and the motor angle measurement value.

In some embodiments, to simplify a configuration structure and reduce costs, the motor sensor (including the motor torque sensor and the motor position sensor) may alternatively be fully configured only in the motor of the robot joint module, and only the joint torque sensor is configured in the joint. In this way, in such a sensor configuration state, the robot system may directly obtain the motor torque measurement value, the motor angle measurement value, and the joint torque measurement value, and only needs to determine the joint angle simulation value in an indirect simulation manner.

In a possible implementation, the robot system first obtains a motor angular velocity through first-order differential calculation based on the motor angle measurement value, and obtains a motor angular acceleration through second-order differential calculation. Further, to obtain the parameter simulation values on the joint side, the robot system needs to determine a reducer input torque between the motor and the joint based on a first dynamic feature of the motor, the motor angular acceleration, and the motor torque measurement value.

In an embodiment, the motor angle measurement value may be denoted as θ(t), the motor angular velocity may be denoted as \dot{θ}(t), and the motor angular acceleration may be denoted as \ddot{θ}(t). By using a first dynamic equation τₘ(t)=B\ddot{θ}(t)+τ_{f}(t)+τ_{w}(t) for the motor, the robot system may obtain the reducer input torque τ_{w} through inverse solution, where t denotes a current moment, τₘ denotes the motor torque measurement value, B denotes the rotor moment of inertia, and τ_{f} denotes a motor friction torque.

Further, considering that the joint has a delay effect relative to running of the motor, to simulate a joint angular velocity at a current moment, the robot system may first replace the joint angle at the current moment with a joint angle at a previous moment, and then the robot system may solve a joint angular velocity simulation value at the current moment based on a second dynamic feature of the joint, the reducer input torque, a stiffness characteristic between a motor angle at the current moment and a joint angle at the previous moment, and a damping characteristic between a motor angular velocity at the current moment and the joint angular velocity.

In an embodiment, the joint angle at the previous moment may be denoted as q(t−1). The robot system may determine the joint angular velocity \dot{q}(t) at the current moment based on the second dynamic feature τ_{w}(t)=K(θ(t)−q(t−1))+D(\dot{θ}(t)−\dot{q}(t)) of the joint, where τ_{w}(t) denotes the reducer input torque at the current moment, K denotes a joint stiffness coefficient, and D denotes a joint damping coefficient.

After obtaining the joint angular velocity simulation value at the current moment, the robot system may determine a joint angular acceleration estimation value by performing differential processing on the joint angular velocity simulation value, and may further determine an external acting torque estimation value at the current moment based on a third dynamic feature of the joint, the joint angular velocity simulation value, the joint angular acceleration estimation value, and the joint angle at the previous moment.

In an embodiment, the joint angular acceleration may be denoted as \ddot{q}(t). The robot system may solve the external acting torque estimation value \hat{τ}ₑₓₜ(t) at the current moment based on a third dynamic feature τ_{w}(t)=M(q(t−1))\hat{\ddot{q}}(t)+C(q(t−1),\dot{q}(t)\dot{q}(t)+g(q(t−1)+τ_{q}(t)−\hat{τ}ₑₓₜ(t) of the joint, where \hat{\ddot{q}}(t) denotes the joint angular acceleration estimation value at the current moment, M(q) denotes an inertial matrix between the motor and the joint, C(q, \dot{q}) denotes a centrifugal and Coriolis matrix, g(q) denotes a gravity matrix, τ_{q} denotes a joint friction torque, and \hat{τ}ₑₓₜ denotes an external acting torque.

In an embodiment, the third dynamic feature of the joint may be transformed into \ddot{q}(t)=M⁻¹(q(t−1)[τ_{w}(t)−(C(q(t−1),\dot{q}(t)\dot{q}(t)+g(q(t−1)+τ_{q}(t)−\hat{τ}ₑₓₜ(t))]. Further, the robot system may substitute the external acting torque estimation value back into the third dynamic feature of the joint, to determine the joint angular acceleration simulation value at the current moment, and then obtain the joint angle simulation value through numerical integration based on the joint angle at the previous moment, the joint angular velocity simulation value, and the joint angular acceleration simulation value.

In a configuration when the joint position sensor is not configured, the joint angle simulation value is obtained through simulation calculation based on the dynamic features of the motor and the joint, the motor torque measurement value, and the motor angle measurement value, to obtain the full set of joint parameters. This ensures closed-loop control of the robot joint module and enhances control precision.
3) In a case that the motor sensor is fully configured and the joint position sensor is configured, the joint torque simulation value is obtained in an indirect simulation based on the motor angle measurement value and the joint angle measurement value.

In some embodiments, to simplify a configuration structure and reduce costs, the motor sensor (including the motor torque sensor and the motor position sensor) may alternatively be fully configured only in the motor of the robot joint module, and only the joint position sensor is configured in the joint. In this way, in such a sensor configuration state, the robot system may directly obtain the motor torque measurement value, the motor angle measurement value, and the joint angle measurement value, and only needs to determine the joint torque simulation value in an indirect simulation manner.

In a possible implementation, the robot system may first determine a first angle difference between the motor angle and the joint angle based on a fourth dynamic feature of the joint, the motor angle measurement value, and the joint angle measurement value. The first angle difference is equal to the motor angle measurement value minus the joint angle measurement value. Further, the joint torque simulation value may be obtained by performing stiffness calculation on the first angle difference based on the joint stiffness coefficient. That is, the joint torque simulation value is equal to the joint stiffness coefficient multiplied by the first angle difference.

In an embodiment, the fourth dynamic feature of the joint may be expressed as τ(t)=K(θ(t)−q(t)), where τ(t) denotes a joint torque at the current moment, K denotes the joint stiffness coefficient, θ(t) denotes a motor angle at the current moment, and q(t) denotes a joint angle at the current moment.

In a configuration where the joint torque sensor is not configured, the joint torque simulation value is obtained through simulation calculation based on the dynamic features of the joint, the motor angle measurement value, and the joint angle measurement value, to obtain the full set of joint parameters. This ensures closed-loop control of the robot joint module and enhances control precision.

Operation 304: Determine, based on the joint parameter simulation value and the parameter measurement values, the motor parameter and the joint parameter that are configured for closed-loop control of the robot joint module.

In some embodiments, after determining the joint parameter simulation value based on the current sensor configuration state, the robot system may determine, based on the parameter measurement values and the joint parameter simulation value, the motor parameter and the joint parameter that are configured for closed-loop control of the robot joint module.

In an embodiment, when the motor sensor is fully configured and the joint sensor is not configured, the motor parameter includes the motor torque measurement value and the motor angle measurement value, and the joint parameter includes the joint torque simulation value and the joint angle simulation value. When the motor sensor is fully configured and the joint torque sensor is configured, the motor parameter includes the motor torque measurement value and the motor angle measurement value, and the joint parameter includes the joint torque measurement value and the joint angle simulation value. In a configuration where the motor sensor is fully configured and the joint position sensor is configured, the motor parameter includes the motor torque measurement value and the motor angle measurement value, and the joint parameter includes the joint torque simulation value and the joint angle measurement value.

Implementations when the Motor Sensor is not Fully Configured

Operation 305: Determine a motor parameter simulation value based on the parameter measurement values and a parameter determination policy where the motor sensor is not fully configured and the joint sensor is fully configured.

In an embodiment, to enhance control precision of the robot joint module, at least the motor torque sensor is configured on the motor. That is, the motor sensor not being fully configured refers to a case when the motor position sensor is not configured. In this case, the robot system needs to determine a motor angle simulation value based on collected joint parameter measurement values and the parameter determination policy.

In an embodiment, when the motor torque sensor is configured and the joint sensor is fully configured, a motor angle simulation value is obtained in an indirect simulation manner based on a joint angle measurement value and a joint torque measurement value.

In some embodiments, to simplify a configuration structure and reduce costs, the joint sensor (including the joint torque sensor and the joint position sensor) may alternatively be fully configured only in the joint of the robot joint module, and only the motor torque sensor is configured in the motor. In this way, in such a sensor configuration state, the robot system may directly obtain the motor torque measurement value, the joint torque measurement value, and the joint angle measurement value, and only needs to determine the motor angle simulation value in an indirect simulation manner.

In a possible implementation, the robot system may obtain a second angle difference between the motor angle and the joint angle through reverse solution based on a fourth dynamic feature of the joint, the joint torque measurement value, and the joint stiffness coefficient, and further determine the motor angle simulation value based on the second angle difference and the joint angle measurement value.

In an embodiment, the fourth dynamic feature of the joint may be expressed as τ(t)=K(θ(t)−q(t)), where τ(t) denotes a joint torque at a current moment, K denotes a joint stiffness coefficient, θ(t) denotes a motor angle at the current moment, and q(t) denotes a joint angle at the current moment. That is, the second angle difference between the motor angle and the joint angle is equal to the joint torque measurement value divided by the joint stiffness coefficient, and the motor angle simulation value is equal to the second angle difference plus the joint angle measurement value.

In a configuration when the motor position sensor is not configured, the motor angle simulation value is obtained through inverse solution based on the dynamic features of the joint, a difference relationship between the motor angle and the joint angle, and a joint stiffness characteristic, to obtain the full set of motor parameters. This ensures closed-loop control of the robot joint module and enhances control precision.

Operation 306: Determine, based on the motor parameter simulation value and the parameter measurement values, the motor parameter and the joint parameter that are configured for closed-loop control of the robot joint module.

In some embodiments, after determining the motor parameter simulation value based on the current sensor configuration state, the robot system may determine, based on the parameter measurement values and the motor parameter simulation value, the motor parameter and the joint parameter that are configured for closed-loop control of the robot joint module.

In an embodiment, when the motor torque sensor is configured and the joint sensor is fully configured, the motor parameter includes the motor torque measurement value and the motor angle simulation value, and the joint parameter includes the joint torque measurement value and the joint angle measurement value.

### Process of Implementing Closed-Loop Control Based on a Control Policy

Operation 307: Determine a motor control torque of the motor based on the motor parameter, the joint parameter, and a control policy, and control the motor, to implement closed-loop control of the robot joint module.

In some embodiments, after obtaining the full set of motor parameters and the full set of joint parameters, the robot system may determine a motor control torque by using a unified control framework based on the motor parameter, the joint parameter, and the control policy, and further control the motor based on the motor control torque, to implement closed-loop control of the robot joint module.

In a possible implementation, a dynamic equation for the robot joint module may be expressed as:

$$\{ \begin{matrix}M ( q ) \ddot{q} + C ( q , \dot{q} ) \dot{q} + g ( q ) = τ + D {K}^{- 1} \dot{τ} - {τ}_{q} + {τ}_{ext} \\ B \ddot{θ} + τ + D {K}^{- 1} \dot{τ} = {τ}_{m} - {τ}_{f} \\ τ = K ( θ - q )\end{matrix}$$

where M(q) denotes the inertial matrix between the motor and the joint, C(q, \dot{q}) denotes the centrifugal and Coriolis matrix, g(q) denotes the gravity matrix, \ddot{q} denotes the joint angular acceleration, \dot{q} denotes the joint angular velocity, q denotes the joint angle, τ denotes the joint torque, D denotes the joint damping coefficient, K denotes the joint stiffness coefficient, τ_{q} denotes the joint friction torque, τₑₓₜ denotes the external acting torque, B denotes the moment of inertia, τₘ denotes the motor torque, τ_{f} denotes the motor friction torque, \ddot{θ} denotes the motor angular acceleration, and θ denotes the motor angle.

Considering that the robot joint module is a flexible joint, for comparison with a rigid robot, it may be assumed that τᵣ=τ+DK⁻¹\dot{τ}=K(θ−q)+D(\dot{θ}−\dot{q}). Therefore, the dynamic equation for the robot joint module may be expressed as:

$$\{ \begin{matrix}M ( q ) \ddot{q} + C ( q , \dot{q} ) \dot{q} + g ( q ) = {τ}_{r} - {τ}_{q} + {τ}_{ext} \\ B \ddot{θ} + D ( \dot{θ} - \dot{q} ) + K ( θ - q ) = {τ}_{m} - {τ}_{f}\end{matrix}$$

In a possible implementation, to effectively perform closed-loop control on the robot joint module, in the unified control framework provided in the embodiments of this application, a full-state feedback controller may be employed to control the robot joint module.

In an embodiment, a control law of the full-state feedback controller may be expressed as:

$${τ}_{m} = B {B}_{θ}^{- 1} {u}_{mid} + ( I - {BB}_{θ}^{- 1} ) τ + ( D {K}^{- 1} - B {B}_{θ}^{- 1} {D}_{s} {K}^{- 1} ) \dot{τ}$$

where τₘ denotes the motor control torque, u_{mid} denotes a middle variable, B_{θ}=diag(b_{θ,i}), b_{θ,i}<bᵢ, B_{θ} denotes a notional motor moment of inertia, and Dₛ denotes a gain matrix of torque feedback.

In an embodiment, B_{θ}\ddot{θ}+τ+DₛK⁻¹\dot{τ}=u−B_{θ}B⁻¹τ_{f} may be obtained by substituting the control law expression into the dynamic equation of the motor. However, because b_{θ,i}<bᵢ, under the control law, the moment of inertia of the motor is reduced, and the impact of the motor friction torque on running of the robot joint module is also reduced.

In an embodiment, to implement closed-loop control of the robot joint module, in addition to dividing a control layer into a motor layer and a joint layer based on practical running of the robot joint module, the robot system may further construct a Cartesian task layer, that is, perform unified control on the joint by using a generalized Jacobian, to determine a desired position and a desired torque of the joint.

In a possible implementation, when the desired position of the joint is determined based on a Cartesian task, the robot system may perform closed-loop control on the robot joint module based on a desired joint angle and a desired joint angular velocity, to ensure following control precision of the joint.

In another possible implementation, when the desired torque of the joint is determined based on the Cartesian task, the robot system may determine a task execution situation of the robot joint module in Cartesian space based on a Cartesian desired torque, and perform closed-loop control on the robot joint module based on a Cartesian space task, to ensure following control precision of the Cartesian task.

The following describes processes of determining the motor control torque based on two control policies, respectively.
1) In a case that following control is performed on the joint, a first motor control torque of the motor is determined based on the motor parameter, the joint parameter, and an inverse kinematics-based control policy.

In an embodiment, the Cartesian task x may be expressed as \dot{x}=J\dot{q}, where \dot{x} denotes a Cartesian velocity, J denotes a generalized Jacobian matrix, and \dot{q} denotes a joint angular velocity. Therefore, the joint angular velocity may be expressed as \dot{q}^{d}=J+\dot{x}^{d} through inverse kinematics, where a superscript “d” denotes a desired value. In this way, the desired joint angle may be obtained by integrating the desired joint angular velocity.

In some embodiments, in a process of controlling the robot system, due to structural complexity of the robot system, robot joint modules at different parts may need to be controlled separately, that is, joint angular velocities and Cartesian tasks of the robot joint modules at different parts may be different. For example, a moving part and an operating part of a wheeled robot or a mobile robot may be separated, that is, motion control of a base part of the mobile robot may be separated from motion control of another part. Therefore, to improve control efficiency, the robot system may obtain the desired joint angular velocity through inverse kinematics processing based on the Jacobian matrix, the Cartesian velocity, and a module position feature of the robot joint module.

In an embodiment, in a configuration where robot joint modules at different parts of the robot system are separately controlled, a relationship between the Cartesian velocity and the desired joint angular velocity may be expressed as:

$$\{ \begin{matrix}{\dot{x}}_{b} = {J}_{b} {\dot{q}}_{b} \\ {\dot{x}}_{m} = {J}_{m b} {\dot{q}}_{b} + {J}_{m} {\dot{q}}_{m}\end{matrix}$$

where \dot{x}_{b} denotes a Cartesian velocity of a base part, J_{b} denotes a Jacobian matrix corresponding to the base part, \dot{q}_{b} denotes a joint angular velocity of the base part, \dot{x}ₘ denotes a Cartesian velocity of a remaining part, J_{mb} denotes a Jacobian matrix obtained by coupling the base part to the remaining part, Jₘ denotes a Jacobian matrix corresponding to the remaining part, and \dot{q}ₘ denotes a joint angular velocity of the remaining part.

Further, based on inverse kinematics, the desired joint angular velocity may be expressed as:

$${\dot{q}}_{b}^{d} = {J}_{b}^{+} {\dot{x}}_{b}^{d}$$

$${\dot{q}}_{m}^{d} = {J}_{m}^{+} ( {\dot{x}}_{m} - {J}_{m b} {\dot{q}}_{b}^{d} )$$

It can be known from the foregoing process that both the desired joint angular velocity and the desired joint angle may be calculated in advance. In a process of performing continuous following control on the joint of the robot joint module, compensation amounts for the desired velocity and the desired acceleration further need to be considered based on the full-state feedback controller.

In an embodiment, a control law of the full-state feedback controller may be expressed as:

$${τ}_{m} = B {B}_{θ}^{- 1} {u}_{m i d} + ( I - {BB}_{θ}^{- 1} ) τ + ( D {K}^{- 1} - B {B}_{θ}^{- 1} {D}_{s} {K}^{- 1} ) \dot{τ}$$

where τₘ denotes the motor control torque, u_{mid} denotes a middle variable, B_{θ}=diag(b_{θ,i}), b_{θ,i}<bᵢ, B_{θ} denotes a notional motor moment of inertia, and Dₛ denotes a gain matrix of torque feedback.

A control compensation item may be expressed as: u_{mid}=K_{θ}Δθ+D_{θ}Δ\dot{θ}+B_{θ}\ddot{θ}+τₐ, where K_{θ} and D_{θ} denote a stiffness coefficient and a damping coefficient under the inverse kinematics-based control policy, Δθ denotes a desired motor angle difference, Δθ=θ^{d}−θ, θ^{d} denotes the desired motor angle, θ denotes an actual motor angle, τₐ denotes a middle term, and τₐ=M(q^{d})\ddot{q}^{d}+C(q^{d},\dot{q}^{d})\dot{q}^{d}+g(q^{d})+τ_{q}=K(θ^{d}−q^{d})+D(\dot{θ}^{d}−\dot{q}^{d}).

However, in a process of controlling the motor, because only the desired joint angle can be obtained based on the Cartesian task and inverse kinematics, that is, the desired motor angle cannot be determined, in a possible implementation, the robot system may determine a motor angle difference and a motor angular velocity difference based on the desired joint angular velocity, the desired joint angle, and the motor angle. That is, it may be assumed that Δθ₁=θ−q^{d}, the motor angle difference Δθ₁ and the motor angular velocity difference Δ\dot{θ}₁ are obtained by replacing the desired motor angle with the desired joint angle. Further, the robot system may determine a first control compensation amount based on the desired joint angular velocity, the desired joint angle, the motor angle difference, and the motor angular velocity difference.

In an embodiment, the first control compensation amount may be expressed as u_{mid}=K_{θ}Δθ₁+D_{θ}Δ\dot{θ}₁+τ_{mid}, where τ_{mid} denotes the middle term, τ_{mid}=B_{θ}\ddot{θ}+τₐ+τ_{af}, τ_{af} denotes the middle term, and

$${τ}_{a f} = \frac{{B}_{θ} Δ {\ddot{θ}}_{1}^{2} + {D}_{θ} Δ {\dot{θ}}_{1} + {K}_{θ} Δ {θ}_{1}}{K + {D}_{s}} {τ}_{a} .$$

Further, after determining the first control compensation amount, the robot system may determine a first motor control torque based on the first control law corresponding to the inverse kinematics-based control policy, the motor angle difference, the motor angular velocity difference, the first control compensation amount, and the joint torque.

In an embodiment, the first motor control torque may be obtained by substituting the first control compensation amount into the control law expression of the full-state feedback controller:

$${τ}_{m} = B {B}_{θ}^{- 1} ( {K}_{θ} Δ {θ}_{1} + {D}_{θ} Δ {\dot{θ}}_{1} ) + {τ}_{m i d} + ( B {B}_{θ}^{- 1} - 1 ) ( {τ}_{m i d} - τ ) + ( {DK}^{- 1} - {BB}_{θ}^{- 1} {D}_{s} {K}^{- 1} ) \dot{τ}$$

Further, the foregoing formula may be simplified as:

$${τ}_{m} = {K}_{P} Δ {θ}_{1} + {K}_{D} Δ {\dot{θ}}_{1} + {τ}_{m i d} + {K}_{T} ( {τ}_{m i d} - τ ) + {K}_{S} \dot{τ} , where$$

$${K}_{P} = B {B}_{θ}^{- 1} {K}_{θ} , {K}_{D} = B {B}_{θ}^{- 1} {D}_{θ} , {K}_{T} = {BB}_{θ}^{- 1} - 1 , and$$

$${K}_{S} = D {K}^{- 1} - B {B}_{θ}^{- 1} {D}_{s} {K}^{- 1} .$$

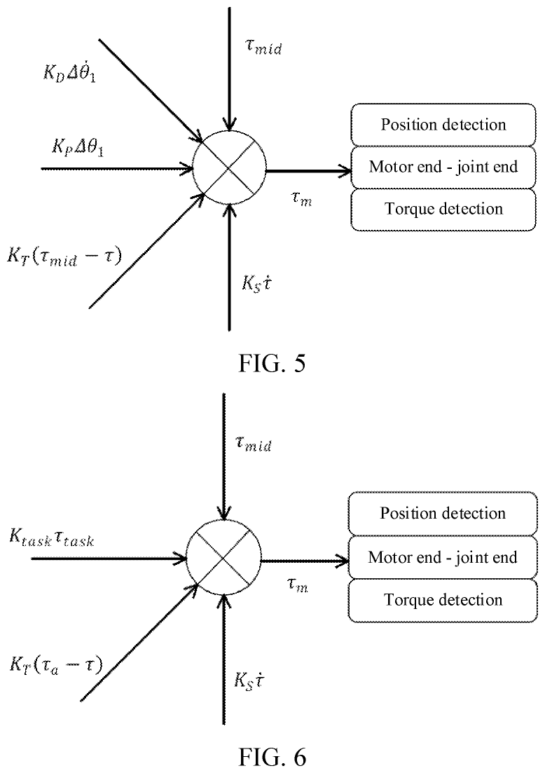

Exemplarily, when the motor is controlled based on the first motor control torque, the full-state feedback controller of the robot joint module may be represented as shown in FIG. 5.

The first control compensation amount is determined based on the inverse kinematics-based control policy, the desired joint angle, and the desired joint angular velocity, and is substituted into the control law expression to obtain the first motor control torque. The motor may be controlled based on the first motor control torque, to implement closed-loop control of the robot joint module. This focus on enhancing following control precision of the joint in the robot joint module.
2) In a case that following control is performed on the Cartesian task, a second motor control torque of the motor is determined based on the motor parameter, the joint parameter, and a Cartesian desired force-based control policy.

In an embodiment, the relationship between the Cartesian velocity and the Cartesian desired torque may be expressed as τₜₐₛₖ=J^{T}(KₓΔx+DₓΔ\dot{x}), where τₜₐₛₖ denotes the Cartesian desired torque, J^{T} denotes a transpose of the Jacobian matrix, Kₓ and Dₓ denote a stiffness coefficient and a damping coefficient under the Cartesian desired force-based control policy, x denotes the Cartesian task, and \dot{x} denotes the Cartesian velocity.

In some embodiments, in a process of controlling the robot system, due to structural complexity of the robot system, robot joint modules at different parts may need to be controlled separately, that is, joint angular velocities and Cartesian tasks of the robot joint modules at different parts may be different. For example, a moving part and an operating part of a wheeled robot or a mobile robot may be separated, that is, motion control of a base part of the mobile robot may be separated from motion control of another part. Therefore, to improve control efficiency, the robot system may obtain the Cartesian desired torque through forward kinematics processing based on the Jacobian matrix, the joint stiffness coefficient, the joint damping coefficient, the Cartesian velocity, and the module position feature of the robot joint module.

In an embodiment, in a configuration where robot joint modules at different parts of the robot system are separately controlled, a relationship between the Cartesian velocity and the Cartesian desired torque may be expressed as:

$${τ}_{task , b} = {J}_{b}^{T} ( {K}_{x , b} Δ {x}_{b} + {D}_{x , b} Δ {\dot{x}}_{b} )$$

$${τ}_{task , m} = {J}_{m}^{T} ( {K}_{x , m} Δ {x}_{m} + {D}_{x , m} Δ {\dot{x}}_{m} ) + {J}_{b m}^{T} ( {K}_{x , b} Δ {x}_{b} + {D}_{x , b} Δ {\dot{x}}_{b} )$$

That is, the Cartesian desired torque of the robot system may be expressed as

$${τ}_{task} = ( \begin{matrix}{τ}_{task , b} \\ {τ}_{t ask , m}\end{matrix} ) ,$$

Where τ_{task,b} denotes a Cartesian desired torque of a base part,

$${J}_{b}^{T}$$

denotes a transpose of a Jacobian matrix corresponding to the base part, K_{x,b} and D_{x,b} denote a stiffness coefficient and a damping coefficient of the base part under the Cartesian desired force-based control policy, x_{b} denotes a Cartesian task for the base part, \dot{x}_{b} denotes a Cartesian velocity of the base part, τ_{task,m} denotes a Cartesian desired torque of a remaining part,

$${J}_{m}^{T}$$

denotes a transpose of a Jacobian matrix corresponding to the remaining part, K_{x,m} and D_{x,m} denote a stiffness coefficient and a damping coefficient of the remaining part under the Cartesian desired force-based control policy, xₘ denotes a Cartesian task for the remaining part, \dot{x}ₘ denotes a Cartesian velocity of the remaining part, and

$${J}_{b m}^{T}$$

denotes a transpose of a Jacobian matrix obtained by coupling the base part to the remaining part.

In a process of performing continuous following control on the Cartesian desired torque of the robot joint module, compensation amounts for the desired velocity and the desired acceleration further need to be considered based on the full-state feedback controller.

In a possible implementation, after determining the Cartesian desired torque of the robot joint module, the robot system may determine a second control compensation amount based on the Cartesian desired torque, the motor angular acceleration, the desired joint angular velocity, and the desired joint angle.

In an embodiment, the second control compensation amount may be expressed as u_{mid}=τₜₐₛₖ+B_{θ}\ddot{θ}+τₐ, where τₜₐₛₖ denotes the Cartesian desired torque, B_{θ} denotes a notional motor moment of inertia, \ddot{θ} denotes the motor angular acceleration, τₐ denotes a middle term, and τₐ=M(q_{d})\ddot{q}^{d}+C(q^{d},\dot{q}^{d})\dot{q}^{d}+g(q^{d})+τ_{q}.

Further, after determining the second control compensation amount, the robot system may determine the second motor control torque based on the second control law corresponding to the Cartesian desired force-based control policy, the desired joint angular velocity, the desired joint angle, the Cartesian desired torque, the second control compensation amount, and the joint torque.

In an embodiment, a control law of the full-state feedback controller may be expressed as:

$${τ}_{m} = B {B}_{θ}^{- 1} {u}_{m i d} + ( I - {BB}_{θ}^{- 1} ) τ + ( D {K}^{- 1} - B {B}_{θ}^{- 1} {D}_{s} {K}^{- 1} ) \dot{τ}$$

where τₘ denotes the motor control torque, u_{mid} denotes a middle variable, B_{θ}=diag(b_{θ,i}), b_{θ,i}<bᵢ, B_{θ} denotes a notional motor moment of inertia, and Dₛ denotes a gain matrix of torque feedback.

In an embodiment, the second motor control torque may be obtained by substituting the second control compensation amount into the control law expression of the full-state feedback controller:

$${τ}_{m} = B {B}_{θ}^{- 1} ( {τ}_{task} + {B}_{θ} \ddot{θ} + {τ}_{a} ) + ( I - {BB}_{θ}^{- 1} ) τ + ( D {K}^{- 1} - B {B}_{θ}^{- 1} {D}_{s} {K}^{- 1} ) \dot{τ}$$

Further, the foregoing formula may be simplified as:

$${τ}_{m} = {K}_{task} {τ}_{task} + {τ}_{m i d} + {K}_{T} ( {τ}_{a} - τ ) + {K}_{S} \dot{τ} , where$$

$${K}_{task} = B {B}_{θ}^{- 1} , {τ}_{m i d} = B \ddot{θ} + {τ}_{a} , {K}_{T} = B {B}_{θ}^{- 1} - 1 , and$$

$${K}_{S} = D {K}^{- 1} - B {B}_{θ}^{- 1} {D}_{s} {K}^{- 1} .$$

Exemplarily, in a configuration where the motor is controlled based on the second motor control torque, the full-state feedback controller of the robot joint module may be represented as shown in FIG. 6.

The Cartesian desired torque is calculated based on the Cartesian desired force-based control policy and the Cartesian space task, to determine the second control compensation amount, and the second motor control torque is obtained by substituting the second control compensation amount into the control law expression. The motor may be controlled based on the second motor control torque, to implement closed-loop control of the robot joint module. This focus on enhancing following control precision of the robot joint module performing the Cartesian task.

In the foregoing embodiments, for different sensor configuration states of the robot joint module, corresponding parameter simulation values are determined in an indirect simulation manner based on the collected parameter measurement values and different parameter determination policies. Then, the full set of motor parameters and the full set of joint parameters that are configured for closed-loop control of the robot joint module are determined based on the parameter measurement values and the parameter simulation values. In this way, different robot joint modules in the robot system can be controlled by using the unified control framework. This ensures control precision of the robot joint modules and reduces control costs of the robot system.

In addition, to satisfy different control precision requirements, two closed-loop control policies are provided in the embodiments of this application, which are the inverse kinematics-based control policy and the Cartesian desired force-based control policy, respectively. In the inverse kinematics-based control policy, closed-loop control is performed on the robot joint module based on the desired joint angle and the desired joint angular velocity, whereby high following control precision of the joint is achieved. In the Cartesian desired force-based control policy, closed-loop control is performed on the robot joint module based on the Cartesian space task, whereby high following control precision of the Cartesian task is achieved.

### Process of Calibrating Parameters of the Robot Joint Module

In some embodiments, before controlling running of the robot joint module, to improve control efficiency of the robot joint module, the robot system further needs to pre-calibrate some parameters of the motor and the joint in the robot joint module, including motor torque coefficient calibration, motor friction calibration, joint friction calibration, and joint stiffness and damping calibration. The following describes a parameter calibration process through a specific embodiment.

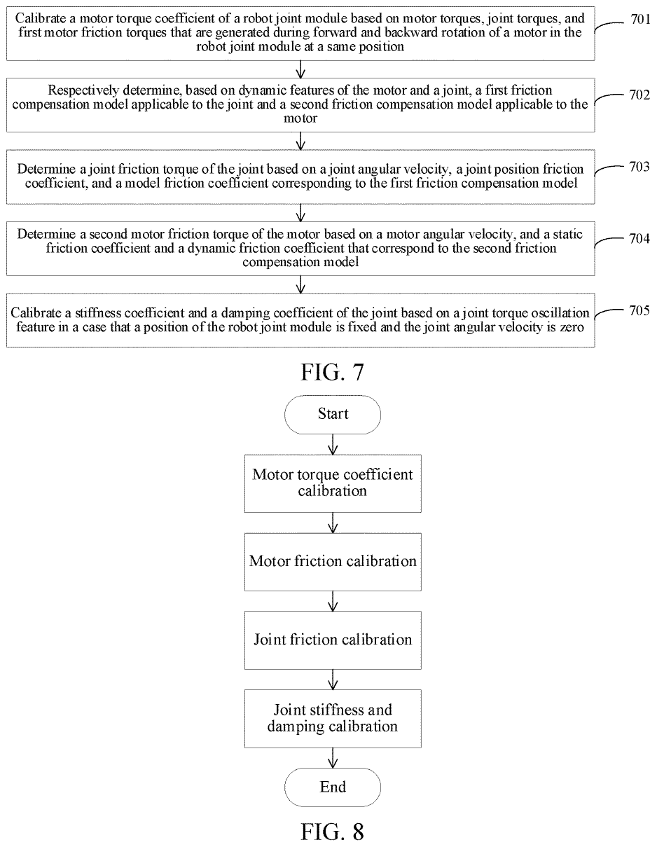

FIG. 7 is a flowchart of performing parameter calibration on a robot joint module according to an exemplary embodiment of this application. This embodiment is described by using an example in which the method is applied to a robot system. The method includes the following operations:

Operation 701: Calibrate a motor torque coefficient of a robot joint module based on motor torques, joint torques, and first motor friction torques that are generated during forward and backward rotation of a motor in the robot joint module at a same position.

In an embodiment, to simplify a process of controlling the robot joint module, it is typically assumed that a motor torque coefficient is a constant, and friction of the motor does not change when the motor moves at the same position at a same velocity.

In an embodiment, to calibrate the motor torque coefficient, the robot system may determine the motor torque coefficient by using a dynamic equation for the motor in the robot joint module during forward and backward motion at the same position. In a possible implementation, the robot system determines, based on the motor torques, the joint torques, and the first motor friction torques that are generated during forward rotation and backward rotation of the motor in the robot joint module at the same position, the dynamic equation corresponding to forward rotation and reverse rotation.

In an embodiment, by using a method for dynamically calibrating the robot joint module, the dynamic equation for the motor during forward rotation and backward rotation at the same position may be expressed as:

$$\{ \begin{matrix}{τ}_{m}^{+} = {K}_{t} {i}_{q}^{+} = τ + \vert {τ}_{f} \vert , \dot{θ} > 0 \\ {τ}_{m}^{-} = {K}_{t} {i}_{q}^{-} = τ - \vert {τ}_{f} \vert , \dot{θ} < 0\end{matrix}$$

where \dot{θ}>0 represents forward rotation of the motor,

$${τ}_{m}^{+}$$

denotes the motor torque during forward rotation,

$${i}_{q}^{+}$$

denotes a current during forward rotation, \dot{θ}<0 represents backward rotation of the motor,

$${τ}_{m}^{-}$$

denotes the motor torque during backward rotation,

$${i}_{q}^{-}$$

denotes a current during backward rotation, Kₜ denotes a motor torque coefficient, τ denotes a joint torque, and τ_{f} denotes a friction torque.

Further, the robot system may eliminate, by adding the equations based on the dynamic equation for the motor during forward and backward rotation, impact of a friction force on the motor torque coefficient, to obtain a relationship among a motor torque system, a current during forward and backward rotation, and the joint torque, solve the motor torque coefficient, and calibrate the motor torque coefficient of the robot joint module.

Operation 702: Respectively determine, based on dynamic features of the motor and a joint, a first friction compensation model applicable to the joint and a second friction compensation model applicable to the motor.

In some embodiments, a difference between the dynamic features of the motor and the joint in the robot joint module is primarily reflected in that a reduction ratio between the motor and the joint causes the motor to move a high velocity and the joint to move at a low velocity. This consequently leads to a difference between friction characteristics of the motor and the joint. Therefore, to respectively determine the dynamic features of the motor and the joint, a transmission chain of the robot joint module may be divided into a motor coordinate system and a joint coordinate system. Therefore, the dynamic equation may be expressed as:

$$\{ \begin{matrix}{τ}_{m}^{′} = {K}_{c}^{′} {i}_{q} = {B}^{′} N \ddot{θ} + {τ}_{f}^{′} + {τ}_{w}^{′} \\ {τ}_{w} = K ( θ - q ) + D ( \dot{θ} - \dot{q} ) = M ( q ) \ddot{q} + C ( q , \dot{q} ) \dot{q} + g ( q ) + {τ}_{q} - {τ}_{ext}\end{matrix}$$

where a variable X′ represents a value of the variable in the motor coordinate system, and a relationship between a variable X′ in the motor coordinate system and a variable X in the joint coordinate system may be expressed as

$$X = N {X}^{′} . {τ}_{m}^{′}$$

denotes the motor torque,

$${K}_{t}^{′}$$

denotes the motor torque coefficient, i_{q} denotes a motor current, B′ denotes a rotor moment of inertia, N denotes a reduction ratio, \ddot{θ} denotes the motor angular acceleration,

$${τ}_{f}^{′}$$

denotes a motor friction torque,

$${τ}_{w}^{′}$$

denotes the reducer input torque, K denotes the joint stiffness coefficient, D denotes the joint damping coefficient, θ denotes the motor angle, q denotes the joint angle, \dot{θ} denotes the motor angular velocity, \dot{q} denotes the joint angular velocity, \ddot{q} denotes the joint angular acceleration, M(q) denotes the inertial matrix between the motor and the joint, C(q, \dot{q}) denotes the centrifugal and Coriolis matrix, g(q) denotes the gravity matrix, τ_{q} denotes the joint friction torque, and τₑₓₜ denotes the external acting torque.

In a possible implementation, based on the dynamic feature that the motor runs at a high velocity and a joint runs at a low velocity, the robot system may respectively determine the first friction compensation model applicable to the joint and the second friction compensation model applicable to the motor.

In an embodiment, the first friction compensation model may refer to a friction compensation model capable of representing a friction force in a low-velocity system, such as a Coulomb friction model; and the second friction compensation model may refer to a friction compensation model capable of representing a friction force in a high-velocity system, such as a LuGre model.

Operation 703: Determine a joint friction torque of the joint based on a joint angular velocity, a joint position friction coefficient, and a model friction coefficient corresponding to the first friction compensation model.

In a possible implementation, because the joint runs at a low velocity, the robot system may use the first friction compensation model to represent the joint friction torque. Then, the robot system may determine the joint friction torque of the joint based on the joint angular velocity, the joint position friction coefficient, and the model friction coefficient corresponding to the first friction compensation model.

In a configuration where the first friction compensation model is the Coulomb friction model, the joint friction torque may be expressed as τ_{q}=F_{cq} sgn(\dot{q})+σ_{q}\dot{q}+H(q), where τ_{q} denotes the joint friction torque, F_{cq} denotes a Coulomb friction coefficient, \dot{q} denotes the joint angular velocity, sgn denotes a sign function, σ_{q} denotes a viscous friction coefficient, and H(q) denotes a position-dependent friction.

Operation 704: Determine a second motor friction torque of the motor based on a motor angular velocity, and a static friction coefficient and a dynamic friction coefficient that correspond to the second friction compensation model.

In a possible implementation, because the motor runs at a high velocity, the robot system may use the second friction compensation model to represent the motor friction torque. Then, the robot system may determine the second motor friction torque of the motor based on the motor angular velocity, and the static friction coefficient and the dynamic friction coefficient that correspond to the second friction compensation model.

In a configuration where the second friction compensation model is the LuGre model, the second motor friction torque may be expressed as:

$$\dot{z} = v - \frac{\vert v \vert}{μ ( v )} {σ}_{0} z$$

$$μ ( v ) = {f}_{c} + ( {f}_{s} - {f}_{c} ) {e}^{- {( v / {v}_{s} )}^{2}}$$

$${τ}_{θ} = {σ}_{0} z + {σ}_{1} \dot{z} + {σ}_{2} v$$

where z denotes an internal state variable of the friction model, namely, a bristle deformation amount, v=\dot{θ} denotes the motor angular velocity, vₛ denotes a Stribeck velocity, fₛ denotes static friction, f_{c} denotes Coulomb friction, τ_{θ} denotes the motor friction torque, σ₀ and σ₁ respectively denote a stiffness coefficient and a damping coefficient of a bristle, and σ₂ denotes a viscous friction coefficient.

For a process of constructing the second friction compensation model, in an embodiment, the robot system may construct the second friction compensation model based on the foregoing formula, the bristle deformation amount, the motor angular velocity, and the static parameter when the motor is in a quasi-static state.

As used herein, the motor being in a quasi-static state means that during running of the motor, an internal dynamic change may be negligible, and the primary focus is on a steady-state characteristic of the motor. In some embodiments, the static parameter may be determined through parameter identification by using a genetic algorithm and a rotation velocity-friction curve.

In an embodiment, when the motor is in a quasi-static state, ż=0. Then, the internal state variable may be expressed as

$${z}_{s} = \frac{μ ( v )}{{σ}_{0}} sgn ( v ) .$$

Further, the friction compensation model may be transformed into τ_{θ}=μ(v)sgn(v)+σ₂v=f_{c}+(fₛ−f_{c})e^{-(v/v}^{ₛ}⁾^{²} sgn(v)+σ₂v.

To determine the second motor friction torque, the robot system needs to determine Coulomb friction f_{c}, static friction fₛ, the Stribeck velocity vₛ, the stiffness coefficient σ₀ of the bristle, the damping coefficient σ₁ of the bristle, and the viscous friction coefficient σ₂, respectively.

In a possible implementation, to improve accuracy of parameter determination, the robot system may first determine the friction-rotation velocity curve between a rotation velocity and a motor friction torque based on a transformed friction compensation model by using a constant-velocity following experiment. The friction-rotation velocity curve may be referred to as a Stribeck curve. Further, the robot system identifies a static parameter and a dynamic parameter in the foregoing parameters by using the genetic algorithm. The static parameter may include (f_{c}, fₛ, σ₂, vₛ), and the dynamic parameter may include (σ₀, σ₁).

In a possible implementation, considering inconsistency of the static parameters of the motor during forward and backward rotation, the second friction compensation model may be expressed as:

$${τ}_{θ} = \{ \begin{matrix}{f}_{c}^{+} + ( {f}_{s}^{+} - {f}_{c}^{+} ) {e}^{- {( v / {v}_{s}^{+} )}^{2}} sgn ( v ) + {σ}_{2}^{+} v \\ {f}_{c}^{-} + ( {f}_{s}^{-} - {f}_{c}^{-} ) {e}^{- {( v / {v}_{s}^{-} )}^{2}} sgn ( v ) + {σ}_{2}^{-} v\end{matrix}$$

where in a case of \dot{θ}>0, the static parameter may be expressed as (f_{c}⁺, fₛ⁺, σ₂⁺, vₛ⁺); and in a case of \dot{θ}<0, the static parameter may be expressed as (f_{c}⁻, fₛ⁻, σ₂⁻, vₛ⁻), that is, the to-be-identified static parameters may be uniformly expressed as Ωₛ=(f_{c}⁺, fₛ⁺, σ₂⁺, vₛ⁺, f_{c}⁻, fₛ⁻, σ₂⁻, vₛ⁻).

Further, after determining the static parameter, the robot system may determine the first friction identification error and the first error function based on the motor angular velocity of the motor during forward rotation, the motor angular velocity during backward rotation, and the to-be-identified static parameter. Then, the robot system may determine and calibrate the static friction coefficient when the first error function satisfies an error threshold.

In a possible implementation, during forward rotation of the motor, the robot system may determine a first forward friction identification error based on the forward friction torque measurement value and the forward friction torque prediction value outputted by the second friction compensation model. The first forward friction identification error is equal to the forward friction torque measurement value minus the forward friction torque prediction value. Further, a first forward error function is determined based on the first forward friction identification error, and then a forward static friction coefficient is determined when the first forward error function satisfies a first error threshold. In an embodiment, a calibration value of the forward static friction coefficient may be a coefficient value of the forward static friction coefficient when a function value of the first forward error function reaches a minimum value.

In a possible implementation, during backward rotation of the motor, the robot system may determine a first backward friction identification error based on the backward friction torque measurement value and the backward friction torque prediction value outputted by the second friction compensation model. The first backward friction identification error is equal to the backward friction torque measurement value minus the backward friction torque prediction value. Further, a first backward error function is determined based on the first backward friction identification error, and then a backward static friction coefficient is determined when the first backward error function satisfies a second error threshold. In an embodiment, a calibration value of the backward static friction coefficient may be a coefficient value of the backward static friction coefficient when a function value of the first backward error function reaches a minimum value.

Further, after the forward static friction coefficient and the backward static friction coefficient are determined, the static friction coefficient of the second friction compensation model may be calibrated.

In an embodiment, Ωₛ=(f_{c}⁺, fₛ⁺, σ₂⁺, vₛ⁺, f_{c}⁻, fₛ⁻, σ₂⁻, vₛ⁻) is the unified representation of the to-be-identified friction parameters during forward and backward rotation of the motor. Therefore, the first friction identification error may alternatively be uniformly expressed as eₛ(Ωₛ,\dot{θ})=τ_{θ}(tᵢ)−τ_{θ}(Ωₛ, \dot{θ}, tᵢ), where τ_{θ}(tᵢ) denotes a friction torque measure value at a moment tᵢ, τ_{θ}(Ωₛ, \dot{θ}, tᵢ) denotes a friction torque prediction value at the moment tᵢ outputted by the model, the first error function may be expressed as

$${J}_{s} = \frac{1}{2} \sum {{e}_{s} ( {Ω}_{s} , \dot{θ} )}^{2} .$$

In this way, when Jₛ reaches a minimum value, the robot system may determine the static friction coefficients.

The first forward error function and the first backward error function are respectively constructed based on the friction torques of the motor in two rotation states, namely, a forward rotation state and a backward rotation state, and then the forward static friction coefficient and the backward static friction coefficient are determined. This ensures accuracy of static friction coefficient calibration and further enhances control precision of the robot joint module.

In a possible implementation, after determining the static friction coefficient, the robot system may update the second friction compensation model based on the static friction coefficient, and calibrate the dynamic friction coefficient based on the second friction compensation model, the second friction identification error, and the second error function.

In a possible implementation, the robot system may determine a second friction identification error based on the friction torque measurement values collected during running of the motor and the friction torque prediction value outputted by the second friction compensation model, determine a second error function based on the second friction identification error, and further determine and calibrate the dynamic friction coefficient when the second error function satisfies an error threshold. In an embodiment, a calibration value of the dynamic friction coefficient may be a coefficient value of the dynamic friction coefficient when a function value of the second error function reaches a minimum value.

In an embodiment, the dynamic parameter may be expressed as Ω_{d}=(σ₀,σ₁), and the second friction identification error may be expressed as e_{d}(Ω_{d},\dot{θ})=τₘ(tᵢ)−τₘ(Ω_{d}, tᵢ), where τₘ(tᵢ) denotes a friction torque measurement value at a moment tᵢ, τₘ(Ω_{d},tᵢ) denotes a friction torque prediction value at the moment tᵢ outputted by the model. The second error function may be expressed as J_{d}=w₁Σe_{d}(Ω_{d},tᵢ)²+w₂ max{|e_{d}(Ω_{d}, tᵢ)|}, where w₁ and w₂ denote error weights. In this way, when J_{d} reaches a minimum value, the robot system may determine the dynamic friction coefficients.

The static friction coefficient is first calibrated, the second friction compensation model is updated, the second error function is constructed based on the friction torques during running of the motor, and then the dynamic friction coefficient is determined. This ensures accuracy of dynamic friction coefficient calibration and further enhances control precision of the robot joint module.

Operation 705: Calibrate a stiffness coefficient and a damping coefficient of the joint based on a joint torque oscillation feature when a position of the robot joint module is fixed and the joint angular velocity is zero.

In some embodiments, in addition to calibration of joint friction, in a process of controlling the robot joint module, the joint stiffness coefficient and the joint damping coefficient further need to be determined. Therefore, before controlling running of the robot joint module, the robot system further needs to calibrate joint stiffness and damping.

In a possible implementation, when the position of the robot joint module is fixed and the joint angular velocity is zero, the robot system may excite a joint oscillation by tapping the joint, determine the joint stiffness coefficient and the joint damping coefficient based on the joint torque oscillation feature, and calibrate the joint stiffness coefficient and the joint damping coefficient.

In an embodiment, when the position of the robot joint module is fixed and the joint angular velocity is zero, a dynamic equation for the joint may be expressed as:

$$\{ \begin{matrix}\overline{M} ( q ) \ddot{q} + g ( q ) = τ + D {K}^{- 1} \dot{τ} + {τ}_{ext} \\ τ = K ( \overline{θ} - q )\end{matrix}$$

where M̅(q) denotes a joint-angle-independent moment of inertia, \ddot{q} denotes the joint angular acceleration, g(q) denotes the gravity matrix, τ denotes the joint torque, K denotes the joint stiffness coefficient, D denotes the joint damping coefficient, τₑₓₜ denotes the external acting torque, θ̅ denotes a fixed joint angle, τ=Δτ+τ̅ and q=Δq+q̅ are defined, τ̅=K(θ̅−q̅)=g(q̅) is satisfied, and τ̅ and q̅ denotes a joint torque and a joint angle when the joint is in balance.

Further, first-order Taylor expansion is performed on the gravity matrix g(q), to obtain:

$$\{ \begin{matrix}0 = \overline{M} Δ \ddot{q} + D Δ \dot{q} + ( K + \frac{\partial g ( q )}{\partial q} \vert q = \overline{q} ) Δ q \\ Δ τ = - K Δ q\end{matrix}$$

Therefore, the oscillation equation Δτ=Δτ̅e^{-αt} cos(wt+φ) for the joint may be determined, where α denotes an attenuation coefficient, w denotes an angular velocity, φ denotes a deflection angle, and Δτ̅ is determined based on a coefficient of a general solution to the foregoing second-order differential equation, and represents an intensity of each tapping.

Further, the joint damping coefficient D=2αM̅ and the joint stiffness coefficient

$$K = {w}^{2} \overline{M} + \frac{{D}^{2}}{4 M} - \frac{\partial g ( q )}{\partial q} \vert q = \overline{q}$$

may be determined based on the dynamic equation for the joint, the first-order Taylor expansion formula for the gravity matrix, and the oscillation equation for the joint.

In the foregoing embodiment, a parameter calibration procedure shown in FIG. 8 is sequentially performed, to provide sufficient basis for subsequent parameter calculation involved in a running process of the robot joint module. This improves control efficiency of the robot joint module and optimizes control precision of the robot joint module.

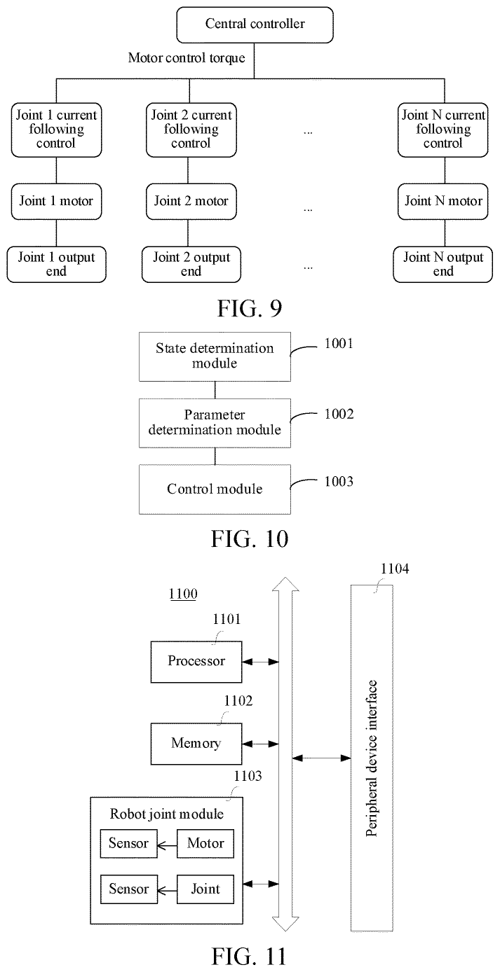

FIG. 9 is a diagram of an implementation framework of a control algorithm for a robot system according to an exemplary embodiment of this application.

In a process of controlling the robot joint modules in the robot system by using the control method for a robot system provided in the embodiments of this application, when parameter measurement and detection are respectively performed on the robot joint modules, even if a variety of sensor configuration states exist, the robot system may obtain, based on existing parameter measurement values and parameter determination policies corresponding to the sensor configuration states, remaining parameter simulation values in an indirect simulation manner. Then, the robot system may determine the full set of motor parameters and the full set of joint parameters that are configured for closed-loop control of the robot joint modules. In this way, a central controller determines motor control torques corresponding to the robot joint module by using the unified control policy framework, without the need for setting corresponding controllers for the robot joint module in different sensor configuration states. This reduces control costs of the robot system, ensures control precision, and improves control efficiency of the robot system.

FIG. 10 is a structural block diagram of a control apparatus for a robot system according to an exemplary embodiment of this application. The apparatus includes:
the robot system including at least one robot joint module, each of the at least one robot joint module including a motor and a joint, and the motor being configured to drive the joint to implement joint motion;
a state determination module 1001, configured to determine a sensor configuration state of the robot joint module, the sensor configuration state including a motor sensor configuration state of the motor in the robot joint module and a joint sensor configuration state of the joint in the robot joint module;
a parameter determination module 1002, configured to determine, based on parameter measurement values collected in the sensor configuration state and a parameter determination policy corresponding to the sensor configuration state, a motor parameter and a joint parameter that are configured for closed-loop control of the robot joint module; and
a control module 1003, configured to determine a motor control torque of the motor based on the motor parameter, the joint parameter, and a control policy, and control the motor to implement closed-loop control of the robot joint module.

In an embodiment, the parameter determination module 1002 includes:
a first parameter determination unit, configured to determine, when both a motor sensor and a joint sensor are fully configured, a parameter measurement value obtained from the motor sensor as the motor parameter configured for closed-loop control of the robot joint module, and determine a parameter measurement value obtained from the joint sensor as the joint parameter configured for closed-loop control of the robot joint module;
a second parameter determination unit, configured to determine a joint parameter simulation value based on the parameter measurement values and the parameter determination policy when the motor sensor is fully configured and the joint sensor is not fully configured; and determine, based on the joint parameter simulation value and the parameter measurement values, the motor parameter and the joint parameter that are configured for closed-loop control of the robot joint module; and
a third parameter determination unit, configured to determine a motor parameter simulation value based on the parameter measurement values and the parameter determination policy when the motor sensor is not fully configured and the joint sensor is fully configured; and determine, based on the motor parameter simulation value and the parameter measurement values, the motor parameter and the joint parameter that are configured for closed-loop control of the robot joint module.

In an embodiment, the motor sensor includes a motor torque sensor and a motor position sensor, and the joint sensor includes a joint torque sensor and a joint position sensor. The motor parameter includes a motor angle and a motor torque, and the joint parameter includes a joint angle and a joint torque.

The second parameter determination unit is configured to:
obtain a joint angle simulation value and a joint torque simulation value in an indirect simulation manner based on a motor torque measurement value and a motor angle measurement value when the motor sensor is fully configured and the joint sensor is not configured;
obtain the joint angle simulation value in an indirect simulation manner based on the motor torque measurement value and the motor angle measurement value when the motor sensor is fully configured and the joint torque sensor is configured; or
obtain the joint torque simulation value in an indirect simulation manner based on the motor angle measurement value and a joint angle measurement value when the motor sensor is fully configured and the joint position sensor is configured.

The third parameter determination unit is configured to:
obtain a motor angle simulation value in an indirect simulation manner based on the joint angle measurement value and a joint torque measurement value when the motor torque sensor is configured and the joint sensor is fully configured.

In an embodiment, the second parameter determination unit is further configured to:
determine a motor angular velocity and a motor angular acceleration based on the motor angle measurement value;
determine a reducer input torque based on a first dynamic feature of the motor, the motor angular acceleration, and the motor torque measurement value;
determine a joint angular velocity simulation value based on a second dynamic feature of the joint, the reducer input torque, a stiffness characteristic between a motor angle at a current moment and a joint angle at a previous moment, and a damping characteristic between a motor angular velocity at the current moment and a joint angular velocity;
perform differential processing on the joint angular velocity simulation value, to obtain a joint angular acceleration estimation value;
determine an external acting torque estimation value based on a third dynamic feature of the joint, the joint angular velocity simulation value, the joint angular acceleration estimation value, and the joint angle at the previous moment;
obtain a joint angular acceleration simulation value through inverse solution based on the third dynamic feature, the joint angular velocity simulation value, the reducer input torque, the external acting torque estimation value, and the joint angle at the previous moment; and
obtain the joint angle simulation value through numerical integration based on the joint angle at the previous moment, the joint angular velocity simulation value, and the joint angular acceleration simulation value.

In an embodiment, the second parameter determination unit is further configured to:
determine a first angle difference based on a fourth dynamic feature of the joint, the motor angle measurement value, and the joint angle measurement value; and
perform stiffness calculation on the first angle difference based on a joint stiffness coefficient, to obtain the joint torque simulation value.

In an embodiment, the third determination unit is further configured to:
obtain a second angle difference between the motor angle and the joint angle through inverse solution based on a fourth dynamic feature of the joint, the joint torque measurement value, and a joint stiffness coefficient; and
determine the motor angle simulation value based on the second angle difference and the joint angle measurement value.

In an embodiment, the apparatus further includes:
a first coefficient calibration module, configured to calibrate a motor torque coefficient of the robot joint module based on motor torques, joint torques, and first motor friction torques that are generated during forward and backward rotation of the motor in the robot joint module at a same position;
a model determination module, configured to respectively determine, based on dynamic features of the motor and the joint, a first friction compensation model applicable to the joint and a second friction compensation model applicable to the motor;
a first torque determination module, configured to determine a joint friction torque of the joint based on the joint angular velocity, a joint position friction coefficient, and a model friction coefficient corresponding to the first friction compensation model;
a second torque determination module, configured to determine a second motor friction torque of the motor based on the motor angular velocity, and a static friction coefficient and a dynamic friction coefficient that correspond to the second friction compensation model; and
a second coefficient calibration module, configured to calibrate a stiffness coefficient and a damping coefficient of the joint based on a joint torque oscillation feature when a position of the robot joint module is fixed and the joint angular velocity is zero.

In an embodiment, the apparatus further includes:
a model construction module, configured to construct the second friction compensation model based on a bristle deformation amount, the motor angular velocity, and a static parameter when the motor is in a quasi-static state, the static parameter being determined through parameter identification by using a genetic algorithm and a rotation velocity-friction curve;
a third coefficient calibration module, configured to calibrate the static friction coefficient based on a motor angular velocity during forward rotation of the motor, a motor angular velocity during backward rotation of the motor, a first friction identification error, and a first error function; and
a fourth coefficient calibration module, configured to calibrate the dynamic friction coefficient based on the second friction compensation model, a second friction identification error, and a second error function.

In an embodiment, the third coefficient calibration module is configured to: determine a first forward friction identification error based on a forward friction torque measurement value and a forward friction torque prediction value outputted by the second friction compensation model during forward rotation of the motor;
determine a first forward error function based on the first forward friction identification error;
determine a forward static friction coefficient when the first forward error function satisfies a first error threshold;
determine a first backward friction identification error based on a backward friction torque measurement value and a backward friction torque prediction value outputted by the second friction compensation model during backward rotation of the motor;
determine a first backward error function based on the first backward friction identification error;
determine a backward static friction coefficient when the first backward error function satisfies a second error threshold; and
calibrate the static friction coefficient of the second friction compensation model based on the forward static friction coefficient and the backward static friction coefficient.

In some embodiments, the control module 1003 includes:
a first torque determination unit, configured to determine a first motor control torque of the motor based on the motor parameter, the joint parameter, and an inverse kinematics-based control policy when following control is performed on the joint; and
a second torque determination unit, configured to determine a second motor control torque of the motor based on the motor parameter, the joint parameter, and a Cartesian desired force-based control policy when following control is performed on a Cartesian task.

In an embodiment, the first torque determination unit is configured to:
obtain a desired joint angular velocity through inverse kinematics processing based on a Jacobian matrix, a Cartesian velocity, and a module position feature of the robot joint module;
determine a motor angle difference and a motor angular velocity difference based on the desired joint angular velocity, a desired joint angle, and the motor angle;
determine a first control compensation amount based on the desired joint angular velocity, the desired joint angle, the motor angle difference, and the motor angular velocity difference; and
determine the first motor control torque based on a first control law corresponding to the inverse kinematics-based control policy, the motor angle difference, the motor angular velocity difference, the first control compensation amount, and the joint torque.

In an embodiment, the second torque determination unit is configured to:
obtain a Cartesian desired torque through forward kinematics processing based on a Jacobian matrix, the joint stiffness coefficient, a joint damping coefficient, a Cartesian velocity, and a module position feature of the robot joint module;
determine a second control compensation amount based on the Cartesian desired torque, the motor angular acceleration, a desired joint angular velocity, and a desired joint angle; and
determine the second motor control torque based on a second control law corresponding to the Cartesian desired force-based control policy, the desired joint angular velocity, the desired joint angle, the Cartesian desired torque, the second control compensation amount, and the joint torque.

In conclusion, in the embodiments of this application, to perform closed-loop control on the robot joint module having different sensor configuration states in a unified control framework, the sensor configuration state of the robot joint module first needs to be determined. Then, the motor parameter and the joint parameter that are required for closed-loop control of the robot joint module are determined based on the parameter measurement values collected in the sensor configuration state and the parameter determination policy corresponding to the current sensor configuration state. Finally, the motor control torque corresponding to the control policy is obtained based on the motor parameter, the joint parameter, and the control policy, and the motor is controlled based on the motor control torque, to implement closed-loop control of the robot joint module. According to the solutions provided in the embodiments of this application, corresponding parameter determination policies are set for different sensor configuration states, to obtain a full set of motor parameters and a full set of joint parameters that are required for closed-loop control, and then closed-loop control is performed on the robot joint module in different sensor configuration states by using the unified control framework, without the need for adopting a particular control policy for the robot joint module in different sensor configuration states. This enhances control precision of the robot joint module and reduces control costs of the robot system.

The apparatus provided in the foregoing embodiments is described by merely using division of the foregoing functional modules as an example. In practical application, the foregoing functions may be allocated to and completed by different functional modules according to requirements. In other words, an internal structure of the apparatus is divided into different functional modules, to complete all or part of the functions described above. In addition, the apparatus provided in the foregoing embodiments and the method embodiments fall within the same conception. For details of a specific implementation process, refer to the method embodiments. Details are not described herein again.

FIG. 11 is a structural block diagram of a robot system 1100 according to an exemplary embodiment of this application. Generally, the robot system 1100 includes: a processor 1101, a memory 1102, and at least one robot joint module 1103.

The processor 1101 may include one or more processing cores, such as a 4-core processor or an 8-core processor. The processor 1101 may be implemented in at least one hardware form of a digital signal processor (DSP), a field-programmable gate array (FPGA), and a programmable logic array (PLA). The processor 1101 may alternatively include a main processor and a coprocessor. The main processor refers to a processor configured to process data in an awake state, and is also referred to as a central processing unit (CPU); and the coprocessor refers to a low-power processor configured to process data in a standby state. In some embodiments, the processor 1101 may be integrated with a graphics processing unit (GPU). The GPU is configured to render and draw contents that need to be displayed on a display screen. In some embodiments, the processor 1101 may further include an artificial intelligence (AI) processor, which is configured to process a machine learning-related computing operation.

The memory 1102 may include one or more computer-readable storage media. The computer-readable storage medium may be tangible and non-transitory. The memory 1102 may further include a high-speed random-access memory and a non-volatile memory, such as one or more disk storage devices or flash storage devices. In some embodiments, a non-transitory computer-readable storage medium in the memory 1102 is configured to store at least one instruction, and the at least one instruction is executed by the processor 1101 to implement the control method for a robot system provided in the embodiments of this application.

The robot joint module 1103 may include a motor, a joint, and a sensor. A variety of sensor configuration solutions may be adopted for the motor and the joint. For example, a motor torque sensor and a motor position sensor may be configured on a motor side, and a joint torque sensor and a joint position sensor may be configured on a joint side. For another example, the motor torque sensor and the motor position sensor may be configured on the motor side, and a joint sensor may not be configured on the joint side. A reducer and another possible transmission device may further be installed between the motor and the joint in the robot joint module 1103.

In some embodiments, the robot system 1100 may further include: a peripheral device interface 1104 and at least one peripheral device.

The peripheral device interface 1104 may be configured to connect at least one peripheral device related to input/output (I/O) to the processor 1101 and the memory 1102. In some embodiments, the processor 1101, the memory 1102, and the peripheral device interface 1104 are integrated on a same chip or circuit board. In some other embodiments, any one or two of the processor 1101, the memory 1102, and the peripheral device interface 1104 may be implemented on a single chip or circuit board. This is not limited in this embodiment.

A person skilled in the art may understand that the structure shown in FIG. 11 constitutes no limitation on the robot system 1100, and the robot system may include more or fewer components than those shown in the figure, or some components may be combined, or a different component arrangement may be used.

Embodiments of this application further provide a computer-readable storage medium. The computer-readable storage medium stores at least one program, and the at least one program is loaded and executed by a processor to implement the control method for a robot system according to the foregoing embodiments.

According to an aspect of this application, a computer program product is provided. The computer program product includes computer instructions, and the computer instructions are stored in a computer-readable storage medium. A processor of a terminal reads the computer instructions from the computer-readable storage medium, and executes the computer instructions, to cause the terminal to implement the control method for a robot system provided in the implementations of the foregoing aspect.

A person skilled in the art will appreciate that in one or more of the foregoing examples, the functions described in the embodiments of this application may be implemented by using hardware, software, firmware, or any combination thereof. When implemented by using software, the functions can be stored in a computer-readable storage medium or can be used as one or more instructions or code in a computer-readable storage medium for transmission. The computer-readable storage medium includes a computer storage medium and a communications medium. The communications medium includes any medium that enables a computer program to be transmitted from one place to another. The storage medium may be any available medium accessible to a general-purpose or dedicated computer.

The foregoing descriptions are merely the embodiments of this application, but are not intended to limit this application. Any modification, equivalent replacement, or improvement made within the spirit and principle of this application fall within the scope of protection of this application.

What is claimed is:

1. A robot control method comprising:
determining, by a robot system, a sensor configuration state of a robot joint module of the robot system, the sensor configuration state comprising a motor sensor configuration state of a motor in the robot joint module and a joint sensor configuration state of a joint in the robot joint module;
determining, by the robot system, based on parameter measurement values collected in the sensor configuration state and a parameter determination policy corresponding to the sensor configuration state, a motor parameter and a joint parameter that are configured for closed-loop control of the robot joint module; and
determining, by the robot system, a motor control torque of the motor based on the motor parameter, the joint parameter, and a control policy, and controlling, by the robot system, the motor to implement closed-loop control of the robot joint module.

2. The method according to claim 1, wherein the determining, based on the parameter measurement values collected in the sensor configuration state and the parameter determination policy corresponding to the sensor configuration state, the motor parameter and the joint parameter that are configured for closed-loop control of the robot joint module comprises:
determining, when both a motor sensor and a joint sensor are fully configured, a parameter measurement value obtained from the motor sensor as the motor parameter configured for closed-loop control of the robot joint module, and determining a parameter measurement value obtained from the joint sensor as the joint parameter configured for closed-loop control of the robot joint module;
determining a joint parameter simulation value based on the parameter measurement values and the parameter determination policy when the motor sensor is fully configured and the joint sensor is not fully configured; and determining, based on the joint parameter simulation value and the parameter measurement values, the motor parameter and the joint parameter that are configured for closed-loop control of the robot joint module; or
determining a motor parameter simulation value based on the parameter measurement values and the parameter determination policy when the motor sensor is not fully configured and the joint sensor is fully configured; and determining, based on the motor parameter simulation value and the parameter measurement values, the motor parameter and the joint parameter that are configured for closed-loop control of the robot joint module.

3. The method according to claim 2, wherein the motor sensor comprises a motor torque sensor and a motor position sensor, and the joint sensor comprises a joint torque sensor and a joint position sensor; and the motor parameter comprise a motor angle and a motor torque, and the joint parameters comprise a joint angle and a joint torque; and
the determining the joint parameter simulation value based on the parameter measurement values and the parameter determination policy when the motor sensor is fully configured and the joint sensor is not fully configured comprises:
obtaining a joint angle simulation value and a joint torque simulation value in an indirect simulation manner based on a motor torque measurement value and a motor angle measurement value when the motor sensor is fully configured and the joint sensor is not configured;
obtaining the joint angle simulation value in an indirect simulation manner based on the motor torque measurement value and the motor angle measurement value when the motor sensor is fully configured and the joint torque sensor is configured; or
obtaining the joint torque simulation value in an indirect simulation manner based on the motor angle measurement value and a joint angle measurement value when the motor sensor is fully configured and the joint position sensor is configured; and
the determining the motor parameter simulation value based on the parameter measurement values and the parameter determination policy when the motor sensor is not fully configured and the joint sensor is fully configured comprises:
obtaining a motor angle simulation value in an indirect simulation manner based on the joint angle measurement value and a joint torque measurement value when the motor torque sensor is configured and the joint sensor is fully configured.

4. The method according to claim 3, wherein the obtaining the joint angle simulation value in the indirect simulation manner based on the motor torque measurement value and the motor angle measurement value comprises:
determining a motor angular velocity and a motor angular acceleration based on the motor angle measurement value;
determining a reducer input torque based on a first dynamic feature of the motor, the motor angular acceleration, and the motor torque measurement value;
determining a joint angular velocity simulation value based on a second dynamic feature of the joint, the reducer input torque, a stiffness characteristic between a motor angle at a current moment and a joint angle at a previous moment, and a damping characteristic between a motor angular velocity at the current moment and a joint angular velocity;
performing differential processing on the joint angular velocity simulation value, to obtain a joint angular acceleration estimation value;
determining an external acting torque estimation value based on a third dynamic feature of the joint, the joint angular velocity simulation value, the joint angular acceleration estimation value, and the joint angle at the previous moment;
obtaining a joint angular acceleration simulation value through inverse solution based on the third dynamic feature, the joint angular velocity simulation value, the reducer input torque, the external acting torque estimation value, and the joint angle at the previous moment; and
obtaining the joint angle simulation value through numerical integration based on the joint angle at the previous moment, the joint angular velocity simulation value, and the joint angular acceleration simulation value.

5. The method according to claim 3, wherein the obtaining the joint torque simulation value in the indirect simulation manner based on the motor angle measurement value and the joint angle measurement value comprises:
determining a first angle difference based on a fourth dynamic feature of the joint, the motor angle measurement value, and the joint angle measurement value; and
performing stiffness calculation on the first angle difference based on a joint stiffness coefficient, to obtain the joint torque simulation value.

6. The method according to claim 3, wherein the obtaining the motor angle simulation value in the indirect simulation manner based on the joint angle measurement value and the joint torque measurement value comprises:
obtaining a second angle difference between the motor angle and the joint angle through inverse solution based on a fourth dynamic feature of the joint, the joint torque measurement value, and a joint stiffness coefficient; and
determining the motor angle simulation value based on the second angle difference and the joint angle measurement value.

7. The method according to claim 1, further comprising:
calibrating a motor torque coefficient of the robot joint module based on motor torques, joint torques, and first motor friction torques that are generated during forward and backward rotation of the motor in the robot joint module at a same position;
respectively determining, based on dynamic features of the motor and the joint, a first friction compensation model applicable to the joint and a second friction compensation model applicable to the motor;
determining a joint friction torque of the joint based on the joint angular velocity, a joint position friction coefficient, and a model friction coefficient corresponding to the first friction compensation model;
determining a second motor friction torque of the motor based on the motor angular velocity, and a static friction coefficient and a dynamic friction coefficient that correspond to the second friction compensation model; and
calibrating a stiffness coefficient and a damping coefficient of the joint based on a joint torque oscillation feature when a position of the robot joint module is fixed and the joint angular velocity is zero.

8. The method according to claim 7, further comprising:
constructing the second friction compensation model based on a bristle deformation amount, the motor angular velocity, and a static parameter when the motor is in a quasi-static state, the static parameter being determined through parameter identification by using a genetic algorithm and a rotation velocity-friction curve;
calibrating the static friction coefficient based on a motor angular velocity during forward rotation of the motor, a motor angular velocity during backward rotation of the motor, a first friction identification error, and a first error function; and
calibrating the dynamic friction coefficient based on the second friction compensation model, a second friction identification error, and a second error function.

9. The method according to claim 8, wherein the calibrating the static friction coefficient based on the motor angular velocity during forward rotation of the motor, the motor angular velocity during backward rotation of the motor, the first friction identification error, and the first error function comprises:
determining a first forward friction identification error based on a forward friction torque measurement value and a forward friction torque prediction value outputted by the second friction compensation model during forward rotation of the motor;
determining a first forward error function based on the first forward friction identification error;
determining a forward static friction coefficient when the first forward error function satisfies a first error threshold;
determining a first backward friction identification error based on a backward friction torque measurement value and a backward friction torque prediction value outputted by the second friction compensation model during backward rotation of the motor;
determining a first backward error function based on the first backward friction identification error;
determining a backward static friction coefficient when the first backward error function satisfies a second error threshold; and
calibrating the static friction coefficient of the second friction compensation model based on the forward static friction coefficient and the backward static friction coefficient.

10. The method according to claim 1, wherein the determining the motor control torque of the motor based on the motor parameter, the joint parameter, and the control policy comprises:
determining a first motor control torque of the motor based on the motor parameter, the joint parameter, and an inverse kinematics-based control policy when following control is performed on the joint; or
determining a second motor control torque of the motor based on the motor parameter, the joint parameter, and a Cartesian desired force-based control policy when following control is performed on a Cartesian task.

11. The method according to claim 10, wherein the determining the first motor control torque of the motor based on the motor parameter, the joint parameter, and the inverse kinematics-based control policy comprises:
obtaining a desired joint angular velocity through inverse kinematics processing based on a Jacobian matrix, a Cartesian velocity, and a module position feature of the robot joint module;
determining a motor angle difference and a motor angular velocity difference based on the desired joint angular velocity, a desired joint angle, and the motor angle;
determining a first control compensation amount based on the desired joint angular velocity, the desired joint angle, the motor angle difference, and the motor angular velocity difference; and
determining the first motor control torque based on a first control law corresponding to the inverse kinematics-based control policy, the motor angle difference, the motor angular velocity difference, the first control compensation amount, and the joint torque.

12. The method according to claim 10, wherein the determining a second motor control torque of the motor based on the motor parameter, the joint parameter, and a Cartesian desired force-based control policy comprises:
obtaining a Cartesian desired torque through forward kinematics processing based on a Jacobian matrix, the joint stiffness coefficient, a joint damping coefficient, a Cartesian velocity, and a module position feature of the robot joint module;
determining a second control compensation amount based on the Cartesian desired torque, the motor angular acceleration, a desired joint angular velocity, and a desired joint angle; and
determining the second motor control torque based on a second control law corresponding to the Cartesian desired force-based control policy, the desired joint angular velocity, the desired joint angle, the Cartesian desired torque, the second control compensation amount, and the joint torque.

13. A robot system comprising:
a robot joint module comprising a motor and a joint, the motor configured to drive the joint to implement joint motion;
a memory storing at least one computer instruction; and
a processor configured to execute the at least one computer instruction, wherein upon execution of the at least one computer instruction, the processor is configured to:
determine a sensor configuration state of the robot joint module, the sensor configuration state comprising a motor sensor configuration state of the motor and a joint sensor configuration state of the joint;
determine, based on parameter measurement values collected in the sensor configuration state and a parameter determination policy corresponding to the sensor configuration state, a motor parameter and a joint parameter that are configured for closed-loop control of the robot joint module; and
determine a motor control torque of the motor based on the motor parameter, the joint parameter, and a control policy, and control the motor to implement closed-loop control of the robot joint module.

14. The robot system according to claim 13, wherein to determine, based on the parameter measurement values collected in the sensor configuration state and the parameter determination policy corresponding to the sensor configuration state, the motor parameter and the joint parameter that are configured for closed-loop control of the robot joint module, the processor, upon execution of the at least one computer instructions, is configured to:
determine, when both a motor sensor and a joint sensor are fully configured, a parameter measurement value obtained from the motor sensor as the motor parameter configured for closed-loop control of the robot joint module, and determine a parameter measurement value obtained from the joint sensor as the joint parameter configured for closed-loop control of the robot joint module;
determine a joint parameter simulation value based on the parameter measurement values and the parameter determination policy when the motor sensor is fully configured and the joint sensor is not fully configured; and determine, based on the joint parameter simulation value and the parameter measurement values, the motor parameter and the joint parameter that are configured for closed-loop control of the robot joint module; or
determine a motor parameter simulation value based on the parameter measurement values and the parameter determination policy when the motor sensor is not fully configured and the joint sensor is fully configured; and determine, based on the motor parameter simulation value and the parameter measurement values, the motor parameter and the joint parameter that are configured for closed-loop control of the robot joint module.

15. The robot system according to claim 13, wherein the processor, upon execution of the at least one computer instruction, is further configured to:
calibrate a motor torque coefficient of the robot joint module based on motor torques, joint torques, and first motor friction torques that are generated during forward and backward rotation of the motor in the robot joint module at a same position;
respectively determine, based on dynamic features of the motor and the joint, a first friction compensation model applicable to the joint and a second friction compensation model applicable to the motor;
determine a joint friction torque of the joint based on the joint angular velocity, a joint position friction coefficient, and a model friction coefficient corresponding to the first friction compensation model;
determine a second motor friction torque of the motor based on the motor angular velocity, and a static friction coefficient and a dynamic friction coefficient that correspond to the second friction compensation model; and
calibrate a stiffness coefficient and a damping coefficient of the joint based on a joint torque oscillation feature when a position of the robot joint module is fixed and the joint angular velocity is zero.

16. The robot system according to claim 13, wherein to determine the motor control torque of the motor based on the motor parameter, the joint parameter, and the control policy, the processor, upon execution of the at least one computer instructions, is configured to:
determine a first motor control torque of the motor based on the motor parameter, the joint parameter, and an inverse kinematics-based control policy when following control is performed on the joint; or
determine a second motor control torque of the motor based on the motor parameter, the joint parameter, and a Cartesian desired force-based control policy when following control is performed on a Cartesian task.

17. A non-transitory computer-readable storage medium storing at least one computer instruction, the at least one computer instruction configured to be loaded and executed by a processor, wherein the at least one computer instruction, when loaded and executed by the processor, is configured to cause the processor to:
determine a sensor configuration state of a robot joint module, the sensor configuration state comprising a motor sensor configuration state of a motor of the robot joint module and a joint sensor configuration state of a joint of the robot joint module;
determine, based on parameter measurement values collected in the sensor configuration state and a parameter determination policy corresponding to the sensor configuration state, a motor parameter and a joint parameter that are configured for closed-loop control of the robot joint module; and
determine a motor control torque of the motor based on the motor parameter, the joint parameter, and a control policy, and control the motor to implement closed-loop control of the robot joint module.

18. The non-transitory computer readable storage medium according to claim 17, wherein for the processor to determine, based on the parameter measurement values collected in the sensor configuration state and the parameter determination policy corresponding to the sensor configuration state, the motor parameter and the joint parameter that are configured for closed-loop control of the robot joint module, the at least one computer instruction, when loaded and executed by the processor, is configured to cause the processor to:
determine, when both a motor sensor and a joint sensor are fully configured, a parameter measurement value obtained from the motor sensor as the motor parameter configured for closed-loop control of the robot joint module, and determine a parameter measurement value obtained from the joint sensor as the joint parameter configured for closed-loop control of the robot joint module;
determine a joint parameter simulation value based on the parameter measurement values and the parameter determination policy when the motor sensor is fully configured and the joint sensor is not fully configured; and determine, based on the joint parameter simulation value and the parameter measurement values, the motor parameter and the joint parameter that are configured for closed-loop control of the robot joint module; or
determine a motor parameter simulation value based on the parameter measurement values and the parameter determination policy when the motor sensor is not fully configured and the joint sensor is fully configured; and determine, based on the motor parameter simulation value and the parameter measurement values, the motor parameter and the joint parameter that are configured for closed-loop control of the robot joint module.

19. The non-transitory computer readable storage medium according to claim 17, wherein the at least one computer instructions, when loaded and executed by the processor, is further configured to the processor to:
calibrate a motor torque coefficient of the robot joint module based on motor torques, joint torques, and first motor friction torques that are generated during forward and backward rotation of the motor in the robot joint module at a same position;
respectively determine, based on dynamic features of the motor and the joint, a first friction compensation model applicable to the joint and a second friction compensation model applicable to the motor;
determine a joint friction torque of the joint based on the joint angular velocity, a joint position friction coefficient, and a model friction coefficient corresponding to the first friction compensation model;
determine a second motor friction torque of the motor based on the motor angular velocity, and a static friction coefficient and a dynamic friction coefficient that correspond to the second friction compensation model; and
calibrate a stiffness coefficient and a damping coefficient of the joint based on a joint torque oscillation feature when a position of the robot joint module is fixed and the joint angular velocity is zero.

20. The non-transitory computer readable storage medium according to claim 17, wherein for the processor to determine the motor control torque of the motor based on the motor parameter, the joint parameter, and the control policy, the at least one computer instruction, when loaded and executed by the processor, is configured to cause the processor to:
determine a first motor control torque of the motor based on the motor parameter, the joint parameter, and an inverse kinematics-based control policy when following control is performed on the joint; or
determine a second motor control torque of the motor based on the motor parameter, the joint parameter, and a Cartesian desired force-based control policy when following control is performed on a Cartesian task.
